(19) United States
(12) Patent Application Publication
(10) Pub. No.: US 2023/0153142 A1
(43) Pub. Date: May 18, 2023

(54) SYSTEM AND METHOD FOR ENABLING AN EXECUTION OF A PLURALITY OF TASKS IN A HETEROGENEOUS DYNAMIC ENVIRONMENT

(71) Applicant: Humanitas Solutions Inc., Montreal (CA)

(72) Inventors: Abdo SHABAH, Montreal (CA); Luca G. GIANOLI, Montreal (CA)

(21) Appl. No.: 17/913,336

(22) PCT Filed: Mar. 25, 2020
(86) PCT No.: PCT/IB2020/052835

§ 371 Date: Sep. 21, 2022

Related U.S. Application Data
(60) Provisional application No. 62/824,047, filed on Mar. 26, 2019.

(51) Int. Cl. G06F 9/455; G06F 9/48

(52) U.S. Cl. CPC G06F 9/45558; G06F 9/4881; G06F 2009/4557; G06F 2009/45595

(57) ABSTRACT

A method and a system are provided for enabling an execution of tasks in a heterogeneous dynamic environment. The system includes heterogeneous host machines having corresponding processing resources and including a telecommunication application for enabling the host machine to be part of a telecommunication network with at least one other heterogeneous host machine. The system further includes a virtualization engine for executing a received virtualized element using the corresponding processing resources of the host machine; a geolocation module for providing an indication of a present position of the corresponding host machine; a distributed system orchestrator for managing an execution of a plurality of tasks using at least one of the plurality of heterogeneous host machines; and a task assignment module for assigning each virtualized element to a selected host machine located on the telecommunication network.

### FIELD

The invention relates to data processing. More precisely, one or more embodiments of the invention pertain to a method and system for enabling an execution of a plurality of tasks in a heterogeneous dynamic environment.

### BACKGROUND

Being able to use a plurality of processing devices for executing tasks is of great advantage for various reasons.

However in many cases the use of a plurality of processing devices can be challenging.

For instance, the processing devices may be of various types rendering the execution complicated.

Another issue is the fact that the environment may be dynamic.

There is a need for at least one of a method and a system that will overcome, inter alia, at least one of the above-identified drawbacks.

Features of the invention will be apparent from review of the disclosure, drawings and description of the invention below.

### BRIEF SUMMARY

According to a broad aspect there is disclosed a system for enabling an execution of a plurality of tasks in a heterogeneous dynamic environment, the system comprising a plurality of heterogeneous host machines, each heterogeneous host machine being characterized by corresponding processing resources, each heterogeneous host machine comprising: a telecommunication application for enabling the heterogeneous host machine to be part of a telecommunication network with at least one other heterogeneous host machine; a virtualization engine for executing a received virtualized element using the corresponding processing resources of the heterogeneous host machine; a geolocation module for providing at least an indication of a present position of the corresponding heterogeneous host machine; a distributed system orchestrator for managing an execution of a plurality of tasks using at least one of the plurality of heterogeneous host machines, wherein the plurality of tasks is comprised of a corresponding plurality of virtualized elements, the distributed system orchestrator comprising: a telecommunication application for enabling the distributed system orchestrator to be part of the telecommunication network comprising at least one heterogeneous host machine of the plurality of heterogeneous host machines and a task assignment module for assigning each virtualized element of the plurality of virtualized elements to a selected heterogeneous host machine located on the telecommunication network, wherein the assigning of the virtualized element is performed according to a given multi-period workload placement problem; wherein the given multi-period workload placement problem is determined by the distributed system orchestrator using at least the indication of a present position of each available heterogeneous host machine and an indication of corresponding resource availability in at least one heterogeneous host machine of the plurality of heterogeneous host machines and in accordance with at least one given criterion.

According to one or more embodiments, the multi-period workload placement problem is determined by the distributed system orchestrator using information related to heterogeneous host machines joining or leaving the telecommunication network.

According to one or more embodiments, the telecommunication network comprises a virtual ad hoc mobile telecommunication network.

According to one or more embodiments, the multi-period workload placement problem is amended in response to a given event.

According to one or more embodiments, the given event comprises a change in resources available.

According to one or more embodiments, the amendment of the multi-period workload placement problem comprises transferring a virtualized element from a first given heterogeneous host machine directly to a second given heterogeneous host machine.

According to one or more embodiments, the heterogeneous host machines are wireless host machines, further wherein the at least one given criterion is selected from a group consisting of a minimization of host machine utilization costs; a minimization of a number of migrations; a minimization of energy consumption; a minimization of refused workloads; a minimization of host machine physical movements; a throughput of at least one given host machine; a spectrum sharing behavior between at least two pairs of host machines; and an interference between at least two pairs of host machines.

According to one or more embodiments, the telecommunication application of the distributed system orchestrator reserves dedicated suitable routing paths according to the multi-period workload placement problem.

According to one or more embodiments, the given multi-period workload placement problem is further determined using at least one telecommunication network property.

According to one or more embodiments, the at least one telecommunication network property problem comprises at least one of a latency for transferring a first given virtualized element to a given heterogeneous host machine; a latency for migrating a second given virtualized element from a first given heterogeneous host machine to a second given heterogeneous host machine and a network topology.

According to one or more embodiments, the geolocation module further provides an indication of a possible future position of the corresponding heterogeneous host machine; further wherein the given multi-period workload placement problem is further determined using the indication of a possible future position of the corresponding heterogeneous host machine.

According to one or more embodiments, each heterogeneous host machine is being assigned an indication of a corresponding reputation; further wherein the given multi-period workload placement problem is further determined using the indication of a corresponding reputation.

According to one or more embodiments, each heterogeneous host machine comprises an energy module for providing an indication of a corresponding level of energy available; further wherein the given multi-period workload placement problem is further determined using the indication of a corresponding level of energy available.

According to a broad aspect, there is disclosed a method for enabling an execution of a plurality of tasks in a heterogeneous dynamic environment, the method comprising providing a plurality of heterogeneous host machines, each given heterogeneous host machine having corresponding processing resources, each given heterogeneous host machine comprising a telecommunication application for enabling the given heterogeneous host machine to be part of a telecommunication network with at least one other heterogeneous host machine, a virtualization engine for executing a received virtualized element using the corresponding processing resources, and a geolocation module for providing at least an indication of a present position of the given heterogeneous host machine; providing a distributed system orchestrator for managing an execution of a plurality of tasks using at least one of the plurality of heterogeneous host machines with a corresponding telecommunication application for enabling the distributed system orchestrator to be part of the telecommunication network comprising at least one available heterogeneous host machine of the plurality of heterogeneous host machines and with a task assignment module for assigning each virtualized element of the plurality of virtualized elements to a selected heterogeneous host machine located on the telecommunication network; receiving, using the distributed system orchestrator, a plurality of tasks to execute, each task comprising a corresponding plurality of virtualized elements; obtaining, using the distributed system orchestrator, an indication of a present location of each available heterogeneous host machine; obtaining, using the distributed system orchestrator, an indication of a resource availability for each available heterogeneous host machine; determining, using the distributed system orchestrator, a multi-period workload placement problem using the received indication of a present location of each available heterogeneous host machine and the indication of a resource availability of each available heterogeneous host machine; and for each task of the plurality of tasks assigning each corresponding virtualized element of the plurality of corresponding virtualized elements to a corresponding host machine using the determined multi-period workload placement problem.

According to one or more embodiments, the method further comprises executing each of the assigned virtualized elements using the corresponding heterogeneous host machine.

According to one or more embodiments, the method further comprises amending the multi-period workload placement problem in response to a given event.

According to one or more embodiments, the method further comprises assigning, for each of the plurality of heterogeneous host machines, an indication of a corresponding reputation; further wherein the determining of the multi-period workload placement problem is further performed using the plurality of indications of a corresponding reputation.

According to one or more embodiments, the method further comprises obtaining an indication of a corresponding level of energy available in each of the plurality of heterogeneous host machines; further wherein the determining of the multi-period workload placement problem is further performed using the obtained indications of a corresponding level of energy available.

It will be appreciated that the system and the method disclosed above are of great advantage for various reasons.

A first reason is that they enable to use a plurality of heterogeneous host machines to execute a plurality of tasks in a dynamic environment.

Another reason is that they enable the use of heterogeneous host machines.

### BRIEF DESCRIPTION

In order that the invention may be readily understood, embodiments of the invention are illustrated by way of example in the accompanying drawings.

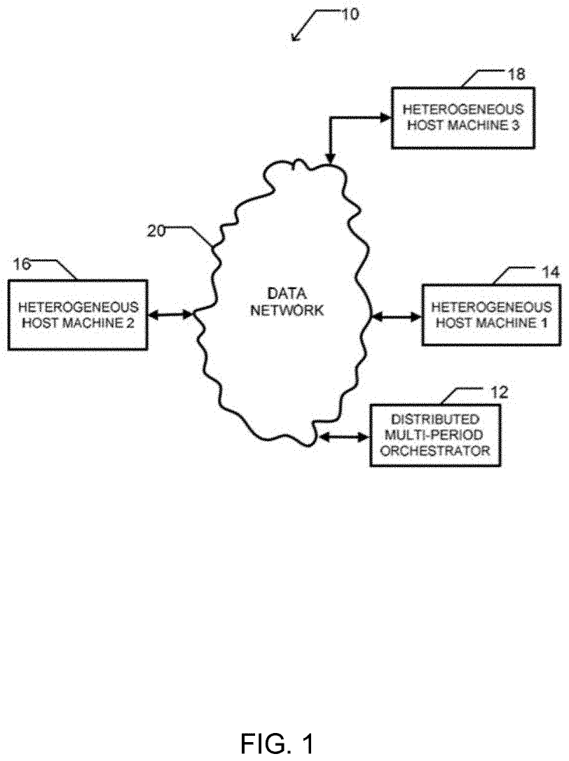

FIG. 1 is a diagram which shows a system for enabling an execution of a plurality of tasks in a heterogeneous dynamic environment comprising three heterogeneous host machines and a distributed system orchestrator.

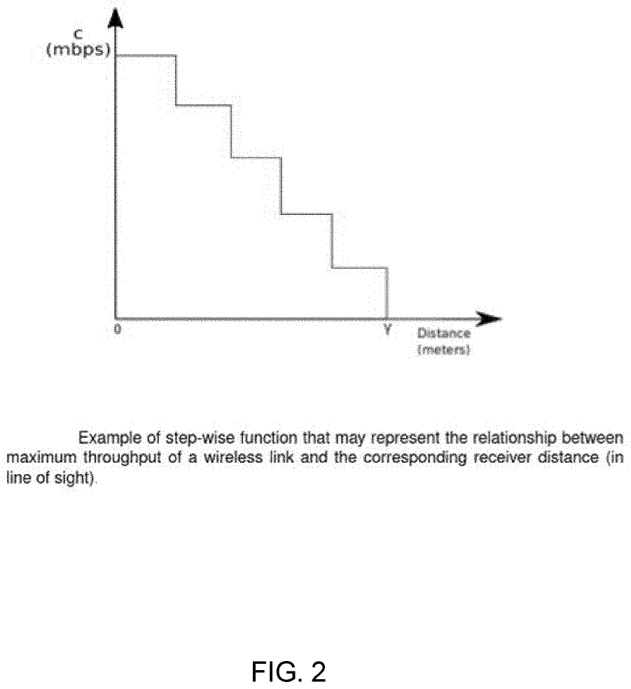

FIG. 2 shows an example of step-wise function that may represent the relationship between maximum throughput of a wireless link and the corresponding receiver distance in line of sight.

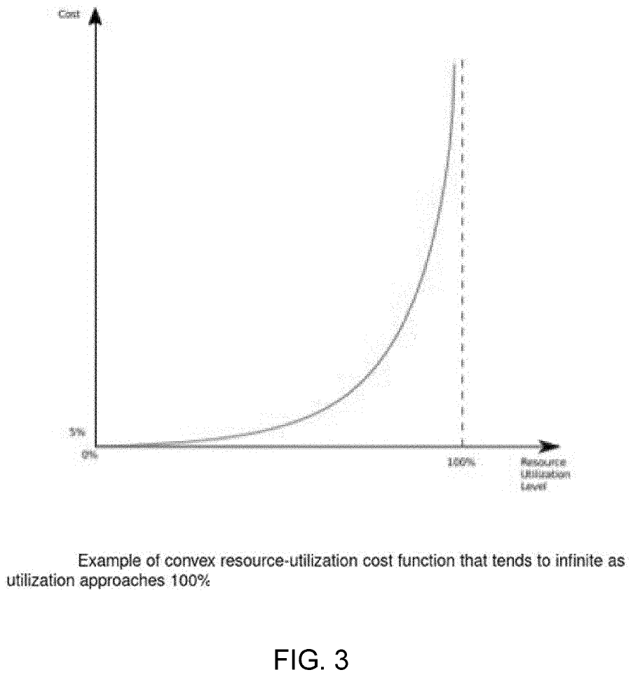

FIG. 3 shows an example of a convex resource-utilization cost function that tends to infinite as utilization approaches 100%.

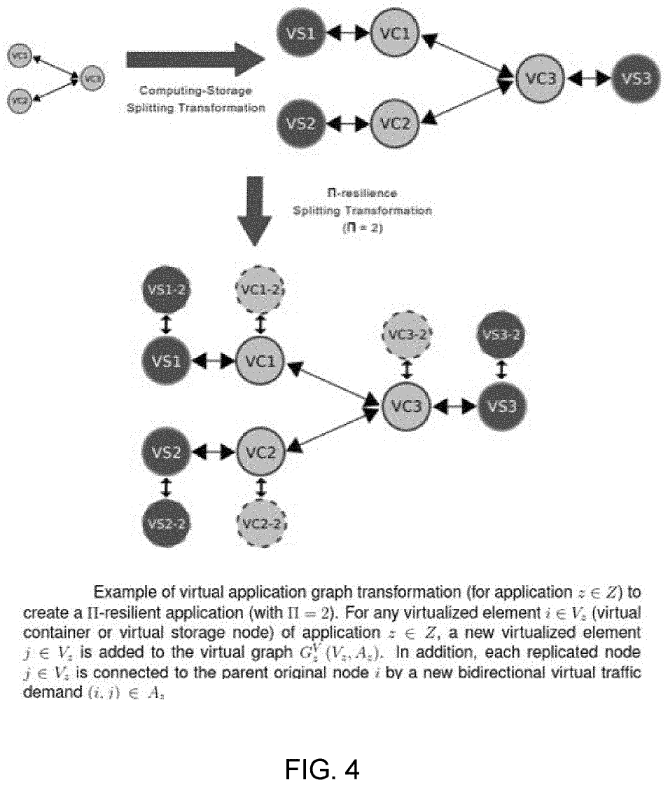

FIG. 4 shows an example of virtual application graph transformation (for application z∈Z) to create a Π-resilient application (with Π=2). For any virtualized element i∈Vz (virtual container or virtual storage node) of application z∈Z, a new virtualized element j∈Vz is added to the virtual graph GzV (Vz, Az). In addition, each replicated node j∈Vz is connected to the parent original node i by a new bidirectional virtual traffic demand (i, j)∈Az.

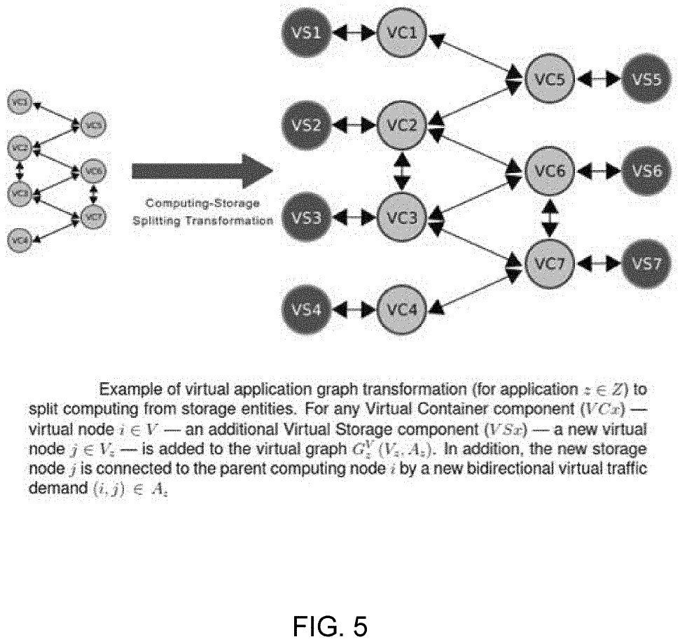

FIG. 5 shows an example of virtual application graph transformation to split computing from storage entities.

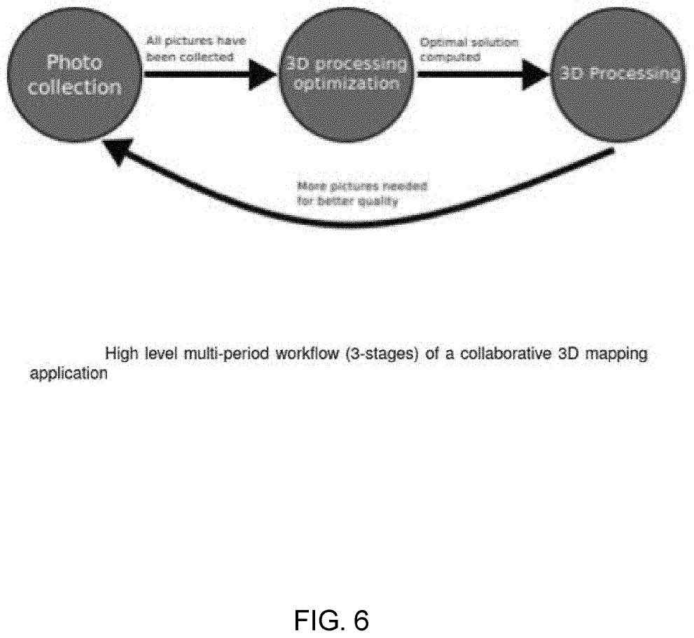

FIG. 6 is a high-level multi-period workflow (3-stages) of a collaborative 3D mapping application.

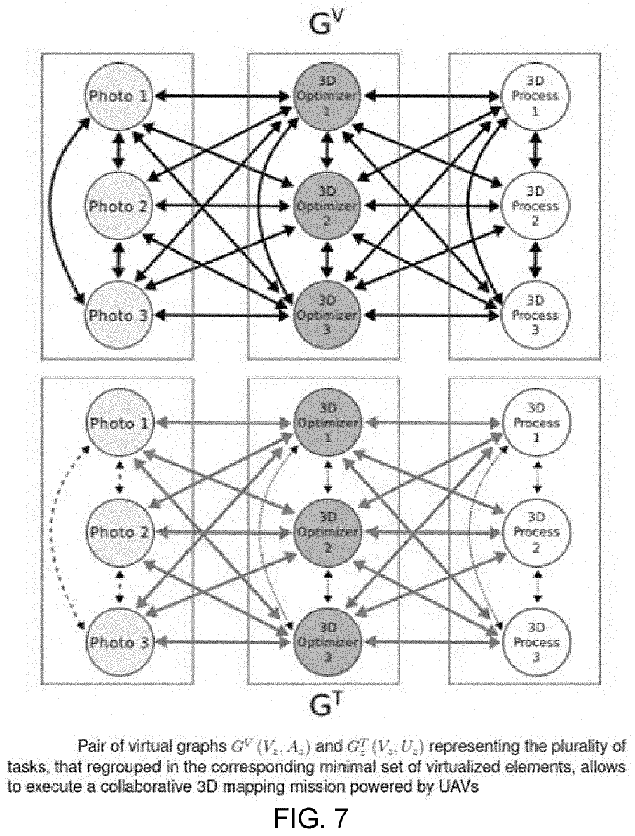

FIG. 7 shows a pair of virtual graphs representing the plurality of tasks, that regrouped in the corresponding minimal set of virtualized elements, allows to execute a collaborative 3D mapping mission powered by UAVs.

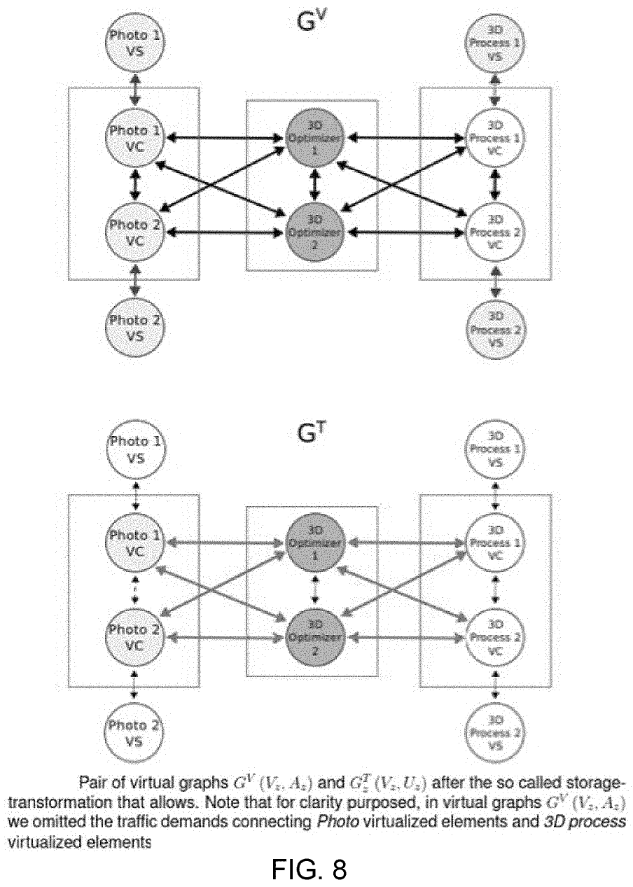

FIG. 8 shows a pair of virtual graphs.

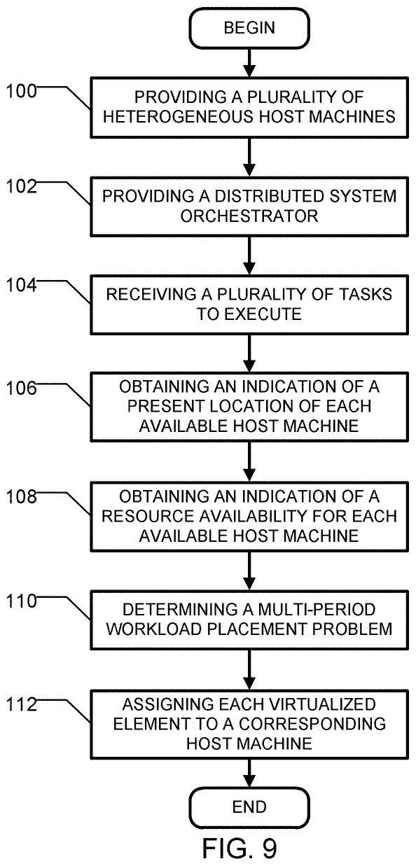

FIG. 9 shows an embodiment of a method for enabling an execution of a plurality of tasks in a heterogeneous dynamic environment.

Further details of the invention and its advantages will be apparent from the detailed description included below.

### DETAILED DESCRIPTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain.

The term “i.e.” and like terms mean “that is,” and thus limit the terms or phrases they explain.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, the present invention is directed to a method and a system for enabling an execution of a plurality of tasks in a heterogeneous dynamic environment.

It will be appreciated that the task may be of various types. In fact, it will be appreciated that a task corresponds to a set of instructions that, during their execution, will consume a given amount of resources (e.g. computing resources, memory resources, storage resources, etc.) or physical capacities (sensors, mobility, etc.).

For instance and in a non-limiting example, in a Web server, a task may be comprised of a set of instructions to receive and manage the requests of a web browser aiming to access a web page.

In the case where an aerial picture has to be taken, a task may comprise a set of instructions to allow an Unmanned Aerial Vehicle (UAV) controlled by a Robot Operating System (ROS) to take and store a picture from a specific point with the desired angle, zoom level, resolution, etc.

Now referring to FIG. 1, there is shown an embodiment of a system for enabling an execution of a plurality of tasks in a heterogeneous dynamic environment.

The system 10 comprises a plurality of heterogeneous host machines and a distributed orchestrator 12. More precisely and in this specific environment, the plurality of heterogeneous host machines comprises a first heterogeneous host machine 14, a second heterogeneous host machine 16 and a third heterogeneous host machine 18. It will be appreciated by the skilled addressee that any number of heterogeneous host machines may be used.

It will be further appreciated that the plurality of heterogeneous host machines are interconnected with the distributed orchestrator 12 via a data network 20. While it is shown a single data network in FIG. 1, it will be appreciated that the interconnection may be performed via a plurality of data networks, each operating using a different protocol. For instance the first heterogeneous host machine 14 may be connected to the data network 20 via a first given data network while the second heterogeneous host machine 16 is connected to the first heterogeneous host machine 14 via a second given data network and the third heterogeneous host machine 16 is connected to the first heterogeneous host machine 14 using a third given data network. It will be appreciated by the skilled addressee that in this embodiment, the second heterogeneous host machine 16 and the third heterogeneous host machine 18 are not directly connected to the distributed orchestrator 12.

It will be appreciated that each host machine is a machine running its own Operating System (OS), e.g., Linux Ubuntu 16.04. It will be appreciated that each host machine is equipped with at least one corresponding processing resource and is characterized by corresponding physical capacities.

The at least one corresponding processing resource may be of various types.

For instance and in one embodiment, the processing resource is a central processing power which can be characterized by a number and a type of Central Processing Unit (CPU).

In another embodiment, the processing resource is a graphics processing power which can be characterized by a number and a type of Graphics Processing Unit (GPU).

In another embodiment, the processing resource is a memory space which is a Random Access Memory (RAM) and which can be characterized by a given size defined in Mbytes (MBs).

In another embodiment, the processing resource is a slow speed memory space which is of the type of the one offered by low-speed Hard Disk Drives (HDDs) and which can be characterized by a size defined in Mbytes (MBs).

In another embodiment, the processing resource is a high speed storage which is of the type of storage space offered by high-speed Solid-State Disks (SSDs) and which can be characterized by a size defined in Mbytes (MBs).

In another embodiment, the processing resource is a networking resource which can be characterized by a number of network interfaces, a bandwidth offered per network interface, and a type of network interfaces.

Moreover, it will be appreciated that the physical capabilities may comprise various sensors, such as for instance RGB camera sensors, infrared camera sensors, temperature sensors.

For instance and in accordance with an embodiment, the physical capability comprises an aerial mobility characterized by a maximum speed, a maximum altitude, etc.

For instance and in accordance with an embodiment, the physical capability comprises a ground mobility characterized by a maximum speed, a steering angle, etc.

For instance and in accordance with an embodiment, the physical capability comprises a physical transportation system characterized by a maximum payload weight, etc.

For instance and in accordance with an embodiment, the physical capability comprises an Internet connectivity.

The skilled addressee will appreciate that the physical capability may be comprised of various other elements known to the skilled addressee.

It will be appreciated that the heterogeneous host machines may therefore comprise a set of host machines having different characteristics in terms of processing resources and physical capacities.

For instance and in accordance with one embodiment, a first heterogeneous host machine may be comprised of a One Onion Omega 2+ running Linux OpenWrt and comprised of a 1 CPU-core running at 580 MHz, 128 MB or RAM, 32 MB of high-speed storage space, 1 mt7628 Wi-Fi interface split into two virtual Wi-Fi interfaces (one access point and one station).

Still in this embodiment, a second heterogeneous host machine may be comprised of a desktop server running Windows 10 and comprising an Intel® Core™ i7-7700T CPU with four 2.9 GHz cores, one Intel® HD Graphics 630, 8 GB of RAM, 1 TB of low-speed storage space, 1 Ethernet 100 Mbps interface, 1 RTL8814au Wi-Fi interface in station mode.

Still in this embodiment, a third heterogeneous host machine may be comprised of a UAV controlled by an NVIDIA TX2 running Ubuntu 16.04 for Tegra architectures and comprised of 6 CPU cores from a HMP Dual Denver 2/2 MB L2+Quad ARM® A57/2 MB L2, one Nvidia Pascal GPU with 256 cores, 8 GB of RAM, 32 GB of high-speed storage space, 1 Gbps Ethernet interface, one 80211.ac Wi-Fi interface in station mode.

The skilled addressee will appreciate that various alternative embodiments may be provided for the heterogeneous host machines.

It will be appreciated that each host machine is running a telecommunication application for enabling the host machine to be part of a telecommunication network with at least one other heterogeneous host machine. In one embodiment, the telecommunication network comprises a virtual ad hoc mobile telecommunication network.

In one embodiment, the telecommunication application comprises a software module running on each physical host machine to enable inter-host communication even through multi-hop routing paths.

For instance and in the embodiment of a set of four host machines such as for instance three Raspberry Pi 3 Model B+ and one Onion Omega 2+, the four devices are connected over Wi-Fi through a hot-spot created by the mt7628 Wi-Fi embedded interface of the Onion Omega 2+(the three RPI Wi-Fi interfaces are connected in station mode to the hot spot). The Onion Omega 2+ manages a WLAN with IP address 192.168.3.0/24, by keeping for itself the IP address 192.168.3.1 and assigning other three distinct IP addresses of the same network to the three RPIs. In this case, the telecommunication module on the Onion Omega 2+ is made by the TCP/IP stack and all related networking services of the OS combined to the Wi-Fi drivers managing the Wi-Fi interface in hot-spot mode, as well as the physical interface itself. On the three Raspberry Pi, the only difference consists in the Wi-Fi drivers used to control with network interface in station mode.

In another embodiment, the four devices are connected over multiple network interfaces. It will be appreciated that the embedded interfaces may be accompanied by other USB network interfaces. A network middleware running in the user space is run on each device to connect all of them on the same multi-hop network by exploiting all the network interfaces available. The telecommunication application of each host machine is now integrated with the network middleware and the other drivers necessary to run the additional external network interfaces.

In another embodiment, the four devices are equipped with a 5G network interface that enable all of them to keep constant connectivity with a server placed in the cloud acting as a bridge between the four devices. In such case, the telecommunication application on each node is made by the TCP/IP stack and all related networking services of the OS combined to the drivers of the 5G interface, as well as the physical interface itself. The telecommunication application includes also the software running in the cloud on the bridge server.

It will be appreciated that each host machine further comprises a virtualization engine. The virtualization engine is used for executing a received virtualized element using the corresponding processing resources of the given host machine.

It will be appreciated that a virtualization engine is a software module that is running on the top of host machines with OS and physical hardware supporting virtualization and which enables to instantiate, run, manage and stop multiple virtualized elements on the same host machine. It will be appreciated by the skilled addressee that the virtualization engine takes care of distributing the processing resources and capacities among all the virtualized elements currently running on the same host machine. It will be appreciated that various virtualization engines may be used such as for instance Docker Engine, Kubernets Engine, Hyper-V, VMWare vSphere, KVM, etc.

It will be appreciated that a virtualized element may be defined as a dedicated software environment instantiated on a host machine, capable, through the process of virtualization, of emulating functions, software modules and hardware not supported by the underlying host machine. For instance it will be appreciated that a virtualized element enables to run for instance a Linux-based application on top of a Windows host machine. It will be further appreciated that a virtualized element runs in an isolated manner with respect to other virtualized elements placed on the same host machines. Most popular examples of virtualized elements include Virtual Containers (VCs) and Virtual Machines (VMs).

It will be further appreciated that each host machine further comprises a geolocation module. The geolocation module is used for providing at least an indication of a present position of the corresponding host machine.

The geolocation module may comprise at least one of a software module and a physical interface and is used for at least estimating a current position of a host machine. The skilled addressee will appreciate that the geolocation module may be of various types.

In one embodiment, the geolocation module comprises a GPS based system comprising a GPS interface which can estimate its position by trilateration with respect to geostationary satellites, as known to the skilled addressee.

In another embodiment, the geolocation module is implemented using a Ultra-Wide Band (UWB) system. In fact, it will be appreciated that in such embodiment three host machines equipped with a UWB interface, such as for instance DWM1001 from DecaWave, may compute a relative position of a fourth host machine always equipped with a UWB interface by trilateration as known to the skilled addressee. It will be appreciated that the distance between each pair of UWB-powered host machines may be computed by estimating a flight time of each transmitted communication probe. If one host machine is chosen as origin of a reference system of coordinates, all the relative positioning measures done by each subset of four host machines can be converted according to it. It will be appreciated that such geolocation module is collaborative and therefore requires all the host machines to be on the same telecommunication network to operate.

In another embodiment, the geolocation module may be implemented using a Wi-Fi range-based system similar to UWB system. In such embodiment, host machines are equipped with a Wi-Fi interface capable of returning the Received Signal Strength Indicator (RSSI) from other host machines in range. The relative positions are computed by converting the Received Signal Strength Indicator (RSSI) into estimated distance values, e.g., by fitting a path loss function. Trilateration processes are thus based on these distance values.

The skilled addressee will appreciate that the geolocation module may be provided according to various alternative embodiments.

Still referring to FIG. 1, it will be appreciated that the system 10 further comprises a distributed orchestrator 12. It will be appreciated that the distributed system orchestrator 12 is used for managing an execution of a plurality of tasks using at least one of the plurality of heterogeneous host machines. The plurality of tasks is comprised of a corresponding plurality of virtualized elements.

It will be appreciated that the distributed system orchestrator 12 comprises a telecommunication application for enabling the distributed system orchestrator 12 to be part of the telecommunication network comprising at least one heterogeneous host machine of the plurality of heterogeneous host machines to thereby be operationally connected with the at least one heterogeneous host machine.

The distributed system orchestrator 12 further comprises a task assignment module. The task assignment module is used for assigning each virtualized element of the plurality of virtualized elements to a selected host machine located on the telecommunication network. It will be further appreciated that the assigning of the virtualized element is performed according to a given multi-period workload placement problem.

The given multi-period workload placement is determined by the distributed system orchestrator 12 using at least the indication of a present position of each available host machine and an indication of corresponding resource availability in each of at least one host machine of the plurality of host machines and in accordance with at least one given criterion. In one embodiment, the multi-period workload placement problem is determined by the distributed system orchestrator 12 using information related to host machines joining or leaving the telecommunication network.

It will be further appreciated that in one embodiment, the given multi-period workload placement problem is further determined using at least one telecommunication network property. The at least one telecommunication network property problem may be selected from a group consisting of a latency for transferring a first given virtualized element to a given host machine, a latency for migrating a second given virtualized element from a first given host machine to a second given host machine, and a network topology.

In fact, it will be appreciated that the distributed system orchestrator 12 comprises a software module running on each host machine to manage, in a collaborative manner, virtualization and all related processes (e.g., reservation of routing paths) within a set of multiple host machines. Differently from traditional centralized orchestration solutions, e.g., VMWare vCenter, Docker Swarm, Openstack Heat, etc., the distributed system orchestrator 12 keeps virtualization decision locally, by empowering different subsets of host machines with the capability of exchanging local system information, and later take real time optimal task assignment decision. The goal of the distributed system orchestrator 12 is to find a set of task assignment decisions that optimizes at least one given criterion. The distributed nature of the distributed system orchestrator 12 is crucial to manage large set of host machines with rapidly varying physical configurations related, for instance, to host machine mobility and temporary availability.

As mentioned above, it will be appreciated that the distributed system orchestrator 12 comprises a task assignment module.

The task assignment module consists of a multi-objective placement problem defined by a Mixed-Integer-Non-Linear-Programming (MINP) formulation. It will be appreciated that in this case the workload placement problem is meant to handle workload with a multi-period nature (i.e. some tasks may not be executable simultaneously). For this reason, it is referred to as multi-period workload placement problem.

Considering a graph made by nodes and arcs representing a set of host machines (nodes) and their physical communication links (arcs), a set of workloads (applications) already placed (mapped) on the top of the set of host machines, each one represented by two dedicated graphs: wherein the first made by nodes and arcs representing a set of virtualized elements (nodes) and their communication bandwidth requirements way they are connected and wherein the second made by nodes and arcs representing a set of virtualized elements (nodes) and their parallelization/serialization constraints—already placed (mapped) on the top of the set of host machines.

Considering also a second set of workloads, represented by the same two graphs just described, demanding to be placed (mapped) on the top of the set of host machines,

It will be appreciated that a multi-period workload placement problem is a mathematical representation of the orchestration process that defines how the placement decisions, e.g., which workload node to virtualize on each host machine, which routing path to assign between different pairs of workload nodes, which workload nodes to put in the waiting queue, which workload already placed on active host machines nodes to migrate to different host machines, where to move a host machine, which host machine to assign to dedicated communication roles, etc.

It will be appreciated that the multi-period workload placement problem defines also which combinations of placement decisions are considered feasible with respect to the system parameters, e.g., the maximum resource of a host machine or the maximum bandwidth of a network link.

In one embodiment, the multi-period workload placement problem is amended in response to a given event.

It will be appreciated that the given event comprises a change in resources available in one embodiment.

It will be further appreciated that that in one embodiment the amendment of the multi-period workload placement problem comprises transferring a virtualized element from a first given host machine directly to a second given host machine.

It will be appreciated that in one embodiment, the telecommunication application of the distributed system orchestrator 12 reserves dedicated suitable routing paths according to the multi-period workload placement problem.

It will be appreciated that each virtualized element has requirements related to the above set of processing resources and capacities. In the context of the placement of a virtualized element on the top of a host machine, the required amount of processing resources is assigned from the host machine to the corresponding virtualized element. The available processing resources are computed as the difference between the total amount of processing resources offered by a host machine in idle state and those currently assigned to the virtualized elements already mapped onto it.

It will be appreciated that the multi-period workload placement problem therefore defines a multi-objective function that the distributed orchestrator is supposed to optimize when computing a multi-period-placement (task-assignment) solution (configuration). It will be appreciated that each objective component is also referred to as a criterion. It will be appreciated that the criterion may be of various types. In one embodiment the at least one criterion is selected from a group consisting of a minimization of host machine utilization costs, a minimization of a number of migrations, a minimization of energy consumption, a minimization of refused workloads, a minimization of host machine physical movements, a throughput of at least one given host machine, a spectrum sharing behavior between at least two pairs of host machines, an interference between at least two pairs of host machines, etc.

It will be appreciated that the given multi-period workload placement problem is further determined using at least one telecommunication network property.

It will be further appreciated that the at least one telecommunication network property problem comprises at least one of a latency for transferring a first given virtualized element to a given host machine; a latency for migrating a second given virtualized element from a first given host machine to a second given host machine; and a network topology.

It will be appreciated that a given event is an event that triggers the need of re-computing a new placement solution with the distributed orchestration. These events include an arrival of a new workload, a resource scarcity observed on a host machine due to unexpected virtualized element resource consumption behavior, a triggering of under-utilization thresholds, a departure of a host machine, an arrival of a new host machine, a conclusion of a task that was blocking the placement of another task of the same workload (application).

It will be appreciated that in one embodiment, the geolocation module further provides an indication of a possible future position of the corresponding host machine. In such case, the given multi-period workload placement problem is further determined using the indication of a possible future position of the corresponding host machine.

It will be appreciated that in one embodiment each heterogeneous host machine is assigned an indication of a corresponding reputation. In such case, the given multi-period workload placement problem is further determined using the indication of a corresponding reputation.

It will be further appreciated that each heterogeneous host machine comprises an energy module for providing an indication of a corresponding level of energy available. In such case, the given multi-period workload placement problem is further determined using the indication of a corresponding level of energy available.

It will be appreciated that there is also disclosed a method for enabling an execution of a plurality of tasks in a heterogeneous dynamic environment.

According to processing step 100, a plurality of heterogeneous host machines is provided. Each given heterogeneous host machine has corresponding processing resources. Each given heterogeneous host machine comprises a telecommunication application for enabling the given heterogeneous host machine to be part of a telecommunication network with at least one other heterogeneous host machine. Each given heterogeneous host machine further comprises a virtualization engine for executing a received virtualized element using the corresponding processing resources. Each given heterogeneous host machine comprises a geolocation module for providing at least an indication of a present position of the given heterogeneous host machine.

According to processing step 102, a distributed system orchestrator is provided for managing an execution of a plurality of tasks using at least one of the plurality of heterogeneous host machines with a corresponding telecommunication application for enabling the distributed system orchestrator to be part of the telecommunication network comprising at least one available heterogeneous host machine of the plurality of heterogeneous host machines and with a task assignment module for assigning each virtualized element of the plurality of virtualized elements to a selected heterogeneous host machine located on the telecommunication network.

According to processing step 104, a plurality of tasks to execute is received using the distributed system orchestrator. Each task comprises a corresponding plurality of virtualized elements.

According to processing step 106, an indication of a present location of each available heterogeneous host machine is obtained using the distributed system orchestrator.

According to processing step 108, an indication of a resource availability for each available heterogeneous host machine is obtained using the distributed system orchestrator.

According to processing step 110, a multi-period workload placement problem is determined by the distributed system orchestrator using the received indication of a present location of each available heterogeneous host machine and the indication of a resource availability of each available heterogeneous host machine.

According to processing step 112, for each task of the plurality of tasks, each corresponding virtualized element of the plurality of corresponding virtualized elements is assigned to a corresponding host machine using the determined multi-period workload placement problem.

In one or more embodiments, the method further comprises executing each of the assigned virtualized elements using the corresponding heterogeneous host machine.

In one or more embodiments of the method, the telecommunication network comprises a virtual ad hoc mobile telecommunication network.

In one or more embodiments, the method further comprises amending the multi-period workload placement problem in response to a given event. In one or more embodiments, the given event comprises a change in resources available.

In one or more embodiments of the method, the amending of the multi-period workload placement problem comprises transferring a given virtualized element from a first given heterogeneous host machine to a second given heterogeneous host machine.

In one or more embodiments of the method, the determining of the multi-period workload placement problem is further performed using at least one property of the telecommunication network.

In one or more embodiments of the method, the method further comprises receiving, from each of the plurality of heterogeneous host machines, an indication of a possible future location; further wherein the determining of the multi-period workload placement problem is further performed using the received indications of a possible future location.

In one or more embodiments of the method, the method further comprises assigning, for each of the plurality of heterogeneous host machines, an indication of a corresponding reputation; further wherein the determining of the multi-period workload placement problem is further performed using the plurality of indications of a corresponding reputation.

In one or more embodiments of the method, the method further comprises obtaining an indication of a corresponding level of energy available in each of the plurality of heterogeneous host machines; further wherein the determining of the multi-period workload placement problem is further performed using the obtained indications of a corresponding level of energy available.

It will be appreciated that the system and the method disclosed above are of great advantage for various reasons.

A first reason is that they enable to use a plurality of heterogeneous host machines to execute a plurality of tasks in a dynamic environment.

Another reason is that they enable the use of heterogeneous host machines.

Although the above description relates to a specific preferred embodiment as presently contemplated by the inventor, it will be understood that the invention in its broad aspect includes functional equivalents of the elements described herein.

Clause 1. A system for enabling an execution of a plurality of tasks in a heterogeneous dynamic environment, the system comprising:

a plurality of heterogeneous host machines, each heterogeneous host machine being characterized by corresponding processing resources, each heterogeneous host machine comprising:
a telecommunication application for enabling the heterogeneous host machine to be part of a telecommunication network with at least one other heterogeneous host machine;
a virtualization engine for executing a received virtualized element using the corresponding processing resources of the heterogeneous host machine;
a geolocation module for providing at least an indication of a present position of the corresponding heterogeneous host machine;

a distributed system orchestrator for managing an execution of a plurality of tasks using at least one of the plurality of heterogeneous host machines, wherein the plurality of tasks is comprised of a corresponding plurality of virtualized elements, the distributed system orchestrator comprising:
a telecommunication application for enabling the distributed system orchestrator to be part of the telecommunication network comprising at least one heterogeneous host machine of the plurality of heterogeneous host machines;
a task assignment module for assigning each virtualized element of the plurality of virtualized elements to a selected heterogeneous host machine located on the telecommunication network, wherein the assigning of the virtualized element is performed according to a given multi-period workload placement problem; wherein the given multi-period workload placement problem is determined by the distributed system orchestrator using at least the indication of a present position of each available heterogeneous host machine and an indication of corresponding resource availability in at least one heterogeneous host machine of the plurality of heterogeneous host machines and in accordance with at least one given criterion.

Clause 2. The system as claimed in clause 1, wherein the multi-period workload placement problem is determined by the distributed system orchestrator using information related to heterogeneous host machines joining or leaving the telecommunication network.

Clause 3. The system as claimed in any one of clauses 1 to 2, wherein the telecommunication network comprises a virtual ad hoc mobile telecommunication network.

Clause 4. The system as claimed in any one of clauses 1 to 3, wherein the multi-period workload placement problem is amended in response to a given event.

Clause 5. The system as claimed in clause 4, wherein the given event comprises a change in resources available.

Clause 6. The system as claimed in clause 4, wherein the amendment of the multi-period workload placement problem comprises transferring a virtualized element from a first given heterogeneous host machine directly to a second given heterogeneous host machine.

Clause 7. The system as claimed in any one of clauses 1 to 6, wherein the heterogeneous host machines are wireless host machines, further wherein the at least one given criterion is selected from a group consisting of:

a minimization of host machine utilization costs;

a minimization of a number of migrations;

a minimization of energy consumption;

a minimization of refused workloads;

a minimization of host machine physical movements;

a throughput of at least one given host machine;

a spectrum sharing behavior between at least two pairs of host machines; and

an interference between at least two pairs of host machines.

Clause 8. The system as claimed in any one of clauses 1 to 7, wherein the telecommunication application of the distributed system orchestrator reserves dedicated suitable routing paths according to the multi-period workload placement problem.

Clause 9. The system as claimed in any one of clauses 1 to 8, wherein the given multi-period workload placement problem is further determined using at least one telecommunication network property.

Clause 10. The system as claimed in clause 9, wherein the at least one telecommunication network property problem comprises at least one of:

a latency for transferring a first given virtualized element to a given heterogeneous host machine;

a latency for migrating a second given virtualized element from a first given heterogeneous host machine to a second given heterogeneous host machine; and

a network topology.

Clause 11. The system as claimed in any one of clauses 1 to 10, wherein the geolocation module further provides an indication of a possible future position of the corresponding heterogeneous host machine; further wherein the given multi-period workload placement problem is further determined using the indication of a possible future position of the corresponding heterogeneous host machine.

Clause 12. The system as claimed in any one of clauses 1 to 11, wherein each heterogeneous host machine is being assigned an indication of a corresponding reputation; further wherein the given multi-period workload placement problem is further determined using the indication of a corresponding reputation.

Clause 13. The system as claimed in any one of clauses 1 to 12, wherein each heterogeneous host machine comprises an energy module for providing an indication of a corresponding level of energy available; further wherein the given multi-period workload placement problem is further determined using the indication of a corresponding level of energy available.

Clause 14. A method for enabling an execution of a plurality of tasks in a heterogeneous dynamic environment, the method comprising:

providing a plurality of heterogeneous host machines, each given heterogeneous host machine having corresponding processing resources, each given heterogeneous host machine comprising:
a telecommunication application for enabling the given heterogeneous host machine to be part of a telecommunication network with at least one other heterogeneous host machine,
a virtualization engine for executing a received virtualized element using the corresponding processing resources, and
a geolocation module for providing at least an indication of a present position of the given heterogeneous host machine;

providing a distributed system orchestrator for managing an execution of a plurality of tasks using at least one of the plurality of heterogeneous host machines with a corresponding telecommunication application for enabling the distributed system orchestrator to be part of the telecommunication network comprising at least one available heterogeneous host machine of the plurality of heterogeneous host machines and with a task assignment module for assigning each virtualized element of the plurality of virtualized elements to a selected heterogeneous host machine located on the telecommunication network;

receiving, using the distributed system orchestrator, a plurality of tasks to execute, each task comprising a corresponding plurality of virtualized elements;

obtaining, using the distributed system orchestrator, an indication of a present location of each available heterogeneous host machine;

obtaining, using the distributed system orchestrator, an indication of a resource availability for each available heterogeneous host machine;

determining, using the distributed system orchestrator, a multi-period workload placement problem using the received indication of a present location of each available heterogeneous host machine and the indication of a resource availability of each available heterogeneous host machine; and

for each task of the plurality of tasks assigning each corresponding virtualized element of the plurality of corresponding virtualized elements to a corresponding host machine using the determined multi-period workload placement problem.

Clause 15. The method as claimed in clause 14, further comprising executing each of the assigned virtualized elements using the corresponding heterogeneous host machine.

Clause 16. The method as claimed in any one of clauses 14 to 15, wherein the telecommunication network comprises a virtual ad hoc mobile telecommunication network.

Clause 17. The method as claimed in any one of clauses 14 to 16, further comprising amending the multi-period workload placement problem in response to a given event.

Clause 18. The method as claimed in clause 17, wherein the given event comprises a change in resources available.

Clause 19. The method as claimed in any one of clauses 14 to 17, wherein the amending of the multi-period workload placement problem comprises transferring a given virtualized element from a first given heterogeneous host machine to a second given heterogeneous host machine.

Clause 20. The method as claimed in any one of clauses 14 to 19, wherein the determining of the multi-period workload placement problem is further performed using at least one property of the telecommunication network.

Clause 21. The method as claimed in any one of clauses 14 to 20, further comprising receiving, from each of the plurality of heterogeneous host machines, an indication of a possible future location; further wherein the determining of the multi-period workload placement problem is further performed using the received indications of a possible future location.

Clause 22. The method as claimed in any one of clauses 14 to 21, further comprising assigning, for each of the plurality of heterogeneous host machines, an indication of a corresponding reputation; further wherein the determining of the multi-period workload placement problem is further performed using the plurality of indications of a corresponding reputation.

Clause 23. The method as claimed in any one of clauses 14 to 22, further comprising obtaining an indication of a corresponding level of energy available in each of the plurality of heterogeneous host machines; further wherein the determining of the multi-period workload placement problem is further performed using the obtained indications of a corresponding level of energy available.

### Technical Implementation of Enabling an Execution of a Plurality of Tasks in a Heterogeneous Dynamic Environment Through a Distributed Orchestration System

### List of Acronyms

| Acronym | Extended Version |
|---|---|
| vCPU | Virtual Central Processing Unit |
| CPU | Central Processing Unit |
| GPU | Graphical Processing Unit |
| RAM | Random Access Memory |
| DDR | Double Data Rate |
| HDD | Hard Disk Drive |
| SSD | Solid State Drive |
| NVMe | Non-Volatile Memory Express |
| SATA | Serial Advanced Technology Attachment |
| MINP | Mixed Integer Non-linear Programming |
| HEAVEN | Heterogeneous Embedded Ad-Hoc Virtual |
| | Emergency Network |
| DASS | Distributed Ad-Hoc Storage Service |
| SLA | Service Level Agreements |
| D2D | Device to Device |
| MCS | Modulation and Coding Scheme |
| IBSS | Independent Basic Service Set |
| OS | Operating System |
| DD | Distributed Database |
| DASS | Distributed Advanced Storage Service |
| MANET | Mobile Ad-Hoc Network |
| OP | Opportunistic Network |
| WLAN | Wireless Local Area Network |
| FOA | Fixed Operation Area |
| AOA | Authorized Operation Area |
| GPS | Global Positioning System |
| UWB | Ultra Wide Band |
| UI | User Interface |
| FP | Feasible Placement |
| OP | Optimal Placement |

### 1 Implementing a Distributed Multi-Period Orchestrator

A practical implementation of a distributed multi-period orchestration system enabling the execution of a plurality of tasks on top of a heterogeneous dynamic virtualization ready physical infrastructure is presented.

The plurality of tasks:
Is resource aware: each task may require computing/storage resources and/or physical capacities (e.g., specific types of sensors, specific types of physical mechanisms, etc.).
Is network aware: each task may require a certain amount of network bandwidth to exchange data with other tasks.
Is mobile: the tasks are tied to specific operation positions.
Is localized: the tasks can be assigned to hosting nodes placed in specific locations.
Is multi-period: the tasks are characterized by inter-tasks precedence, simultaneity, serialization and parallelization relationships that regulate when each single task can be actually placed and executed.
Requires guaranteed QoS: strict guarantees in terms of hosting machine availability and network performance.
Requires best effort QoS: no guarantees in terms of hosting machine availability and network performance.

The heterogeneous dynamic virtualization-ready physical infrastructure:
Is opportunistic: Some hosting machines may appear and depart in both a pre-planned and an uncontrolled manner. A reputation value may be assigned to each hosting machine to evaluate its reliability and trustiness.
Is mobile: Some hosting machines may be capable of moving toward a given position to satisfy the requirements of a hosted virtualized element. Some hosting machines may move in an autonomous manner without direct control of the orchestration system.
Is battery alimented: Some hosting machines may have limited battery life and may need periodical battery recharging.
Is wireless, wired or both: Some hosting machines may be connected through wired communication links—e.g., an Ethernet connection—while other hosting machines may exploit different types of wireless communication links, from Device-to-Device (D2D) ad-hoc wireless links to traditional Wi-Fi managed links and 3G/4G/5G connections.
Is Internet ready: if at least one hosting machine has global connectivity, it seamlessly acts as gateway by all the other hosting machines requiring global connectivity. The availability of global connectivity is not mandatory to operate on the top of the virtualization ready physical infrastructure.
Is virtualization ready: hosting machines offer computing/storage resources, as well as physical capacities (e.g., specific types of sensors, specific types of physical mechanisms, etc.). Note that a hosting machine can manage whole clusters of sensors for which it acts as gateway/sink node over a Wireless Sensor Network (WSN); these sensor clusters represent specific physical capacities and resources that can be assigned to hosted virtualized elements.
Can be geographically widespread: geographical proximity is not necessary to consider two hosting machines as neighbors. Any pairs of hosting machines able to exchange data (e.g., through a TCP socket) can be considered neighbors.

The practical implementation of a distributed multi-period orchestration system enabling the execution of a plurality of tasks on top of a heterogeneous dynamic virtualization-ready physical infrastructure relies on the following list of components:
1. The multi-period workload generation module to allow any user or process to translate a general application comprising multiple tasks into a proper multi-period representation compatible with the new proposed distributed multi-period orchestrator for multi-period workload placement. This component is responsible for generating all the parameters characterizing a given set of heterogeneous tasks. The distributed multiperiod orchestrator can actually work without this auxiliary component, which represents the interface between the orchestrator and any entity aiming to run a set of tasks while improving the virtualization performances observed during system operations. network-aware path planning
2. The distributed multi-period orchestrator is responsible for optimizing how a given set of tasks is placed (mapped) over time, on top of the set of hosting machines representing the virtualization ready physical infrastructure. One instance of the distributed multi-period orchestrator is run on each hosting machine. Two are the key elements of each distributed multi-period orchestrator instance:
   A mathematical formulation of the multi-period workload placement problem.
   A collaborative multi-period placement algorithm to solve, in real-time, the multi-period workload placement problem.
3. A Distributed Advanced Storage Service (DASS) is run on each hosting machine to provide data sharing/replication services to all the other modules hosted by the same hosting machine. For instance, the collaborative multi-period placement algorithm exploits DASS to enable the coordination and the communication among multiple hosting machines.
4. The energy manager is responsible, on each hosting machine, for managing energy-consumption related parameters and energy management processes.
5. The network-aware path manager responsible, on each hosting machine, for computing traveling paths that will guarantee a stable network configuration and a stable network performance whenever a hosting machines is required to move toward the position demanded by a hosted task (virtualized element). The distributed multiperiod orchestrator can work without this auxiliary component. However, network-aware path planning is helpful to improve overall system performances during operations.
6. The geo-location module is responsible, on each hosting machine, for retrieving/estimating/managing all geo-location related parameters.
7. The reputation estimator is responsible, on each hosting machine, for retrieving/estimating/managing all reputation related parameters.
8. The access manager is responsible, on each hosting machine, for accepting (server side) new hosting machines aiming to become members of the virtualization ready physical infrastructure, as well as for gaining (client side) access to the virtualization ready physical infrastructure just discovered.
9. The virtualization engine is responsible, on each hosting machine, for instantiating, monitoring, running, stopping, migrating, isolating the hosted application nodes.
10. The telecommunication application is responsible, on each hosting machine, for guaranteeing connectivity with all the other architecture members. In our example, the role of telecommunication application is assigned to the Heterogeneous Embedded Ad-Hoc Virtual Emergency Network (HEAVEN) middleware capable of establishing and managing an ad-hoc virtual network on the top of Wi-Fi Managed, Wi-Fi IBSS, UWB, Bluetooth, xBee 900 Mhz interfaces.

### 2 Mathematical Notation and Definitions

TABLE 2
Presentation of all the mathematical notation.
It will be appreciated that in the text, the operator underline,
e.g., xᵢⱼ^{z} is used to define the pre-optimization
value of the corresponding variable.

| Symbol | Description |
|---|---|
| Sets | |
| G^{p} (N, E) | Physical graph representing the computing and |
| | networking infrastructure, where N and E |
| | denote the sets of, respectively, bare metal |
| | hosting machines and communication links |
| | (both wired an wireless). |
| N | Set of hosting machines. |
| \hat{N} | Set of hosting machines with battery recharging |
| | capabilities (for other hosting machines). |
| N̅ | Set of hosting machines capable of changing |
| | their positions. |
| Nᵢ | Set of hosting machines not containing hosting |
| | machine i ∈ N:N\{i}. |
| E | Set of physical communication links connecting |
| | the hosting machines. |
| Eᵢ | Set of physical communication links belonging |
| | to the wireless cell of hosting machine i ∈ N. |
| R | Set of resources and physical capacities offered |
| | by hosting machines to virtualized elements |
| | (application nodes). For instance, R = |
| | {CPU, GPU, RAM, HDD, SSD, RGB cameras}. |
| K^{r} | Set of physical configuration available for |
| | resource r ∈ R. Each hosting machine runs one |
| | configuration k ∈ K^{r} for each resource r ∈ R. |
| H^{ij} | Set of horizontal pieces used to represent the |
| | throughput-distance step-wise function that |
| | describes the capacity of physical wireless link |
| | (i, j) ∈ E. Practically speaking, different types of |
| | modulations (see MCS for Wi-Fi 802.11 n/ac) |
| | have different minimum signal strength |
| | requirements at the receiver side, and the signal |
| | strength decreases with as the inter node |
| | distance increases. See FIG. 2. |
| Z | Set containing all the virtual applications (each |
| | made by one ore more virtualized elements) |
| | which are already hosted or demand to be |
| | hosted. |
| Z̅ | Subset of Z containing all the virtual |
| | applications already placed on a subset of |
| | hosting machines. |
| \hat{Z} | Subset of Z containing all the virtual |
| | applications demanding to be hosted on a |
| | subset of hosting machines. |
| G_{z}^{V} (V_{z}, A_{z}) | Virtual graph representing the virtualized |
| | elements (application nodes) and their traffic |
| | demands that constitute a virtual application |
| | z ∈ Z. |
| G^{T} (V_{z}, U_{z}) | Temporal precedence graph representing |
| | precedence/incompatibility/serialization/ |
| | parallelization relationships between the |
| | application nodes i ∈ V_{z} of the same application |
| | z ∈ Z. |
| V_{z} | Set of virtualized elements (application nodes) |
| | (VMs or VCs) of application z ∈ Z. |
| Vᵢ^{z} | Set of virtualized elements (application nodes) |
| | (VMs or VCs) of application z ∈ Z that does not |
| | contain virtualized element (application node) |
| | i ∈ V_{z}:V_{z}\{i}. |
| A_{z} | Set of traffic demands representing the |
| | bandwidth requirements between different pairs |
| | of virtualized element. For instance, 2 mbps of |
| | bandwidth should be reserved between |
| | virtualized element 1 and virtualized element 2. |
| U_{z} | Set of arcs representing the precedence/ |
| | incompatibility/serialization/parallelization |
| | between different pairs of application nodes of |
| | the same application z ∈ Z. These relationships |
| | are expressed by multiple sets that are later |
| | presented in this table. |
| P | Set of routing paths available to interconnect |
| | any pair of hosting machines. Each routing path |
| | is made by a series of consecutive links |
| | connecting the path source to the path |
| | destination. |
| S_{z} | Set of types of virtualized elements used in |
| | application z ∈ Z; All the application nodes of |
| | the same type s ∈ S_{z} can potentially share the |
| | physical resources of the hosting machine |
| | where they are co-placed. |
| Q | Set of sub-clusters. Each sub-cluster is made |
| | by hosting machines and physical |
| | communication links. Note that different |
| \ddot{N}ᵢ | sub-clusters may be overlapping. |
| | Set of hosting machines of sub-cluster i ∈ Q. |
| Ëᵢ | Set of physical network links of sub-cluster |
| | i ∈ Q. |
| \ddot{P}ᵢ | Set of routing paths of sub-cluster i ∈ Q |
| | interconnecting the hosting machines \ddot{N}ᵢ by |
| | exploiting only links of Ëᵢ. |
| Parameters | |
| ωᵢᵣ | Non negative, real. Total amount of resource |
| | r ∈ R available on hosting machine i ∈ N. See |
| | Table 3 for example of unit of measurements for |
| | different resources. |
| Ωᵣ | Non negative in [1, ∞). Over-provisioning |
| | scaling parameter for resource/capacity r ∈ R. |
| | Resource over-subscription can be used to |
| | avoid resource under-utilization. In fact ωᵢᵣ |
| | represent nominal values that can be different |
| | by real resource consumption value observed |
| | after placement. |
| ηᵢₖᵣ | Binary. Equal to 1 if hosting machine i ∈ N is |
| | running with configuration k ∈ K^{r} for resource |
| | r ∈ R. |
| cᵢⱼₕ | Non negative, real. Total bandwidth available on |
| | physical link (i, j) ∈ E when piece h ∈ H^{ij} of the |
| | corresponding throughput distance function |
| | (see FIG. 2) is considered. |
| C | Real parameter ≥ 1. Network bandwidth |
| | over-provisioning parameter. |
| c̅ᵢ | Non negative, real. Total bandwidth reserved on |
| | the wireless cell of hosting machine i ∈ N. |
| lₕ⁺ | Non negative, real. Maximum distance accepted |
| | to activate piece h ∈ H^{ij}. Practically speaking, |
| | after above this distance value, we should |
| | consider another piece corresponding to a lower |
| | value of capacity/throughput. Larger distances |
| | deteriorate the throughput. |
| lₕ⁻ | Non negative, real. Minimum distance accepted |
| | to activate piece h ∈ H^{ij}. Practically speaking, |
| | below this distance value, we should consider |
| | another piece corresponding to a higher value |
| | of capacity/throughput. Smaller distances lead |
| | to improved throughput. |
| ϕᵢᵣ | Non negative, real. Total amount of |
| | resource/capacity r ∈ R demanded by a |
| | virtualized element (application node) i ∈ V_{z} of |
| | application z ∈ Z. |
| ρᵢₖᵣ^{z} | Binary. Equal to 1 if virtualized element |
| | (application node) i ∈ V_{z} of application z ∈ Z |
| | can be placed on a hosting machine running |
| | configuration k ∈ K^{r} in terms of |
| | resource/capacity r ∈ R. |
| δᵢⱼ^{z} | Non-negative, real. Amount of traffic to be |
| | reserved on the physical links connecting the |
| | hosting machines that will serve the pair of |
| | virtualized elements i ∈ V_{z} and j ∈ V_{z} of |
| | application z g Z for which a traffic demand |
| | (i, j) ∈ A_{z} exists. |
| \hat{δ}ᵢ^{z} | Non-negative, real. Amount of traffic to be |
| | reserved on the physical links belonging to the |
| | routing path (or paths) that will be used to |
| | migrate a virtualized element (application node) |
| | i ∈ V_{z} of application z ∈ Z to a new hosting |
| | machine. |
| δ̅ᵢ^{z} | Non-negative, real. Amount of traffic to be |
| | reserved on the physical links belonging to the |
| | routing path (or paths) that will be used to used |
| | to deploy a virtualized element (application |
| | node) i ∈ V_{z} of application z ∈ Z on the |
| | corresponding hosting server. |
| ϵᵢ | Non-negative, real. Fixed energy consumption |
| | component for hosting machine server i ∈ N: ϵᵢ |
| | Watts are consumed any time the hosting |
| | machine is on in idle state. |
| [symbol] | Non-negative, real. Penalty cost paid to refuse |
| | placement to virtual application z ∈ Z. |
| oₚ | Hosting machine from set N representing the |
| | source of routing path p ∈ P. |
| tₚ | Hosting machine from set N representing the |
| | destination of routing path p ∈ P. |
| ιᵢⱼ^{z} | Binary. Equal to 1 if hosting machine i ∈ N is |
| | the deployment node from which a virtualized |
| | element (application node) j ∈ V_{z} of application |
| | z ∈ Z waiting for its first placement will be |
| | transferred to the targeted hosting machine. |
| Δᵢⱼ^{z} | Non-negative, real. Maximum network latency |
| | accepted by traffic demand (i, j) ∈ A_{z} of |
| | application z ∈ Z. |
| bᵢ^{z} | Non negative, real. Penalty cost paid to migrate |
| | a virtualized element i ∈ V_{z} of application z ∈ Z |
| | to a new hosting machines (remind that |
| | migrations causes temporary performance |
| | degradation to the corresponding virtualized |
| | elements). |
| Φᵣ ( ) | Convex function in [0, 1). Utilization cost function |
| | for traditional computing resources. It can be |
| | used to minimize congestion, as well as to price |
| | (monetary value) the available resources. See |
| | Figure 3 for an example. |
| D ( ) | Convex function in [0, 1). Kleinrock delay |
| | function estimating the average packet delay on |
| | a network link. Given a physical link (m, n) ∈ E, |
| | $it can be computed as {D}_{m n} = \frac{1}{{c}_{m n} - {f}_{m n}} . See$ |
| | below the meaning of flow variables f. |
| Λ | Non negative, real. Number of routing paths to |
| | be activated per traffic demand to implement a |
| | multi-tree routing scheme. |
| M_{iz}^{down} | Non negative, real. Maximum total down-time |
| | duration accepted during a migration by the |
| | virtualized element i ∈ V_{z} of application z ∈ Z. |
| Ā_{zij}^{FO} | Binary. Equal to 1 if hosting machine j ∈ N is |
| | placed within the FOA of application node i ∈ V_{z} |
| | of application z ∈ Z. The FOA is the physical |
| | region inside which a hosting machine must lay |
| | to be eligible to host a given virtualized element. |
| (Aᵢ^{DOE}, Aᵢ^{DOW}, | 4-object tuple of non-negative real parameters |
| Aᵢ^{DON}, Aᵢ^{DOS}) | (non-negative because we consider only the |
| | positive quadrant of the Cartesian space). East, |
| | West, North, South boundaries of the |
| | rectangular region representing the DOA of |
| | application node i ∈ V_{z} of application z ∈ Z. The |
| | DOA is the physical region that must be reached |
| | by a hosting machine serving the corresponding |
| | virtualized element to perform its related tasks. |
| (Aᵢ^{AOE}, Aᵢ^{AOW}, | 4-object tuple of non-negative real parameters |
| Aᵢ^{AON}, Aᵢ^{AOS}) | (non-negative because we consider only the |
| | positive quadrant of the Cartesian space). East, |
| | West, North, South boundaries of the |
| | rectangular region representing the AOA of |
| | hosting machine i ∈ N. The AOA is the physical |
| | region inside which a hosting machine can |
| | operate (it cannot go beyond those boundaries). |
| (Aᵢ^{FOE}, Aᵢ^{FOW}, | 4-object tuple of non-negative real parameters |
| Aᵢ^{FON}, Aᵢ^{FOS}) | (non-negative because we consider only the |
| | positive quadrant of the Cartesian space). East, |
| | West, North, South boundaries of the |
| | rectangular region representing the FOA of an |
| | application node i ∈ V_{z} of application z ∈ Z. The |
| | FOA is the physical region inside which a |
| | hosting machine serving the virtualized element |
| | i must be initially placed. |
| χᵢⱼ^{z} | Binary. Equal to 1 if virtualized element |
| | (application node) i ∈ V_{z} of application z ∈ Z |
| | cannot be activated simultaneously with a |
| | second virtualized element (application node) |
| | j ∈ V_{z} of the same application, when both |
| | elements are assigned to the same hosting |
| | machine. This parameter is considered to build |
| | the arc set U_{z} previously presented. |
| χ̅ᵢⱼ^{z} | Binary. Equal to 1 if virtualized elements |
| | i, j ∈ V_{z} of application z ∈ Z have to be run |
| | simultaneously. This parameter is considered to |
| | build the arc set U_{z} previously presented. |
| \hat{χ}ᵢⱼ^{z} | Binary. Equal to 1 if virtualized element |
| | (application node) i ∈ V_{z} of application z ∈ Z |
| | must be already placed on a hosting machine |
| | before that second application node j ∈ V_{z} can |
| | be placed as well. This parameter is considered |
| | to build the arc set U_{z} previously presented. |
| qᵢⱼ^{z} | Binary. Equal to 1 if virtualized element |
| | (application node) i ∈ V_{z} of application z ∈ Z |
| | running on the hosting machine j ∈ N has |
| | concluded the operations that were blocking the |
| | activation of co-placed virtualized elements |
| | (application nodes). For instance a virtualized |
| | element with a certain DOA, may be blocking a |
| | second virtualized element characterized by a |
| | non overlapping DOA. |
| γᵢ^{z} | Binary. Equal to 1 if hosting machine i ∈ N is |
| | not busy and can thus host new virtualized |
| | elements. Practicaly speaking, a hosting |
| | machine is considered busy if it is moving to |
| | accomplish a task of a virtualized element or to |
| | complete a migration. It is desirable to avoid |
| | placing new virtualized elements on unstable |
| | (varying position) hosting machines. |
| γᵢⱼ | Binary. Equal to 1 if physical link (i, j) ∈ E is not |
| | busy. |
| γₚ | Binary. Equal to 1 if path p ∈ P is not busy. |
| κᵢ^{z} | Non-negative, real. The current reputation score |
| | assigned to hosting machine i ∈ N. |
| κ̅ᵢ^{z} | Non-negative, real. The minimum reputation |
| | value demanded by virtualized element |
| | (application node) i ∈ V_{z} of application z ∈ Z. |
| ϑᵢ | Non-negative, real. Maximum moving speed of |
| | hosting machine i ∈ N. |
| Ξᵢ | Non-negative, real. Expected departure time |
| | (with respect to the current time instant) of |
| | hosting machine i ∈ N. |
| Ξ̅ⱼ^{comp} | Non-negative, real. Amount of computing time |
| | explicitly requested by virtualized element |
| | (application node) j ∈ V_{z} of application z ∈ Z. |
| | Practically speaking, a user may need a virtual |
| | container for 3 hours from now. |
| ψ̅ᵢ^{z} | Binary. Equal to 1 if virtualized element |
| | (application node) i ∈ V_{z} of application z ∈ Z |
| | can accept to be placed on a physical machine |
| | which may not be available until the end. |
| Σᵢⱼ^{z} | Binary. Equal to 1 if virtualized element |
| | (application node) i ∈ V_{z} of application z ∈ Z |
| | has to placed on the same physical machine |
| | hosting a second application node j ∈ V_{z}. |
| βᵢ | Binary. Equal to 1 if virtualized element |
| | (application node) i ∈ V_{z} of application z ∈ Z |
| | must be activated at this round of placement. |
| β̅_{z} | Non negative, real. Minimum number of |
| | virtualized elements (application nodes) of |
| | application z ∈ Z that must be placed at this |
| | round of placement to consider the application |
| | served. |
| υᵢₛ^{z} | Binary. Equal to 1 if virtualized element |
| | (application node) i ∈ V_{z} of application z ∈ Z is |
| | of type s ∈ S_{z}. |
| Ξ̅ⱼ^{comm} | Non-negative, real. Amount of time that a |
| | communication node (a hosting machine moved |
| | to improve the network performance of a give |
| | application without directly hosting any of its |
| | virtualized elements) must guarantee to serve |
| | application node j ∈ V_{z} of application z ∈ Z. |
| q̅ᵢₛ^{z} | Binary. Equal to 1 if virtualized element |
| | (application node) i ∈ V_{z} of application z ∈ Z |
| | can share the resources of other application |
| | nodes of the same application z ∈ Z if they are |
| | of the same type s ∈ S_{z}. |
| Σᵢ | Scaling parameters to convert the computing |
| | battery autonomy of hosting machine i ∈ N into |
| | the movement battery autonomy. |
| σᵢ | Battery autonomy in terms of computing time for |
| | hosting machine i ∈ N. |
| nᵢⱼ | Binary. Equal to 1 if node i ∈ N is planning to |
| | move, in the future, toward node j ∈ N. |
| dᵢⱼ | Non negative, real. Expected travel duration to |
| | allow hosting machine i ∈ N to reach hosting |
| | machine j ∈ N. |
| Variables | |
| fᵢⱼ | Non negative, real. Total bandwidth reserved on |
| | network link (i, j) ∈ E to serve classic |
| | application traffic demands (those belonging to |
| | A_{z} for any z ∈ Z). |
| \hat{f}ᵢⱼ | Non negative, real. Total bandwidth reserved on |
| | network link (i, j) ∈ E to support migration |
| | traffic. |
| f̅ᵢⱼ | Non negative, real. Total bandwidth reserved on |
| | network link (i, j) ∈ E to support deployment |
| | traffic. |
| fᵢⱼ^{z} | Non negative, real. Total bandwidth reserved on |
| | network link (i, j) ∈ E to serve traffic demands |
| | A_{z} of application z ∈ Z. |
| \hat{f}ᵢⱼ^{z} | Non negative, real. Total bandwidth reserved on |
| | network link (i, j) ∈ E to support migration |
| | traffic produced by the application nodes of |
| | application z ∈ Z. |
| f̅ᵢⱼ^{z} | Non negative, real. Total bandwidth reserved on |
| | network link (i, j) ∈ E to support deployment |
| | traffic produced by the application nodes of |
| | application z ∈ Z. |
| \dot{f}ᵢⱼ^{z} | Binary. Equal to 1 if network link (i, j) ∈ E |
| | carries traffic belonging to application z ∈ Z. |
| \ddot{f}ᵢⱼ^{z} | Binary. Equal to 1 if hosting machine i ∈ N |
| | carries traffic belonging to application node |
| | j g V_{z} of application z ∈ Z. |
| xᵢⱼ^{z} | Binary. Equal to 1 if virtualized element |
| | (application node) i ∈ V_{z} of application z ∈ Z is |
| | placed on hosting machine j g N. |
| wᵢⱼ^{z} | Binary. Equal to 1 if virtualized element |
| | (application node) i ∈ V_{z} of application z ∈ Z |
| | has to be migrated through the network to fulfill |
| | the new placement configuration on hosting |
| | machine j ∈ N. |
| w̅ᵢⱼ^{z} | Binary. Equal to 1 if virtualized element |
| | (application node) i ∈ V_{z} of application z ∈ Z |
| | has to be physically migrated (active migration) |
| | to hosting machine j ∈ N to fulfill the new |
| | placement configuration. |
| ŵᵢⱼ^{z} | Binary. Equal to 1 if virtualized element |
| | (application node) i ∈ V_{z} of application z ∈ Z |
| | has to be physically migrated (opportunistic |
| | migration) to hosting machine j ∈ N to fulfill the |
| | new mapping configuration. |
| yᵢⱼₕₛ^{z} | Binary. Equal to 1 if virtualized elements |
| | (application nodes) i and j \| (i, d) ∈ A_{z} of |
| | application z ∈ Z are placed on, respectively, |
| | hosting machines h and s ∈ N. |
| y̅ᵢⱼₙ^{z} | Binary. Equal to 1 if two virtualized elements |
| | (application nodes) i ∈ V_{z} and j ∈ V_{z} of the |
| | same application z ∈ Z are co-placed on the |
| | same hosting machine n g N. |
| ċᵢⱼₕ | Binary. Equal to 1 if physical link (i, j) is offering |
| | a capacity level corresponding to that of piece |
| | h ∈ H^{ij}. See FIG. 2. |
| eᵢₕ | Binary. Equal to 1 if hosting machine i ∈ N lays |
| | within the boundaries of the wireless cell of |
| | node h ∈ N\{i}- |
| vᵢ | Binary. Equal to 1 if hosting machine i ∈ N is |
| | active. |
| uᵢᵣ | Non negative, real. Total utilization cost for |
| | resource/capacity r ∈ R on hosting machine |
| | i ∈ N. |
| τᵢⱼ | Non negative, real. Packet latency on physical |
| | link (i, j) ∈ E by considering post-optimization |
| | positions. |
| τ̅ᵢⱼ | Non negative, real. Packet latency on physical |
| | link (i, j) ∈ E by considering pre-optimization |
| | node positions. |
| τₚ | Non negative, real. Total packet latency on |
| | routing path p ∈ P by considering |
| | post-optimization positions. |
| τ̅ₚ | Non negative, real. Total packet latency on |
| | routing path p ∈ P by considering |
| | pre-optimization positions. |
| τᵢ | Non negative, real. Wireless cell utilization cost |
| | for hosting machine i ∈ N by considering |
| | post-optimization positions. |
| τ̅ᵢ | Non negative, real. Wireless cell utilization cost |
| | for hosting machine i ∈ N by considering |
| | pre-optimization positions. |
| g_{z} | Binary. Equal to 1 if virtual application z ∈ Z is |
| | accepted for placement on top of the |
| | virtualization ready physical infrastructure. |
| (λᵢ^{X}, λᵢ^{Y}) | Pair of non-negative real variables |
| | (non-negative because we consider only the |
| | positive quadrant of the Cartesian space) |
| | representing the new position assigned by the |
| | orchestrator to hosting machine i ∈ N. |
| (vᵢⱼ^{X}, vᵢⱼ^{Y}) | Pair of non-negative real variables representing |
| | the distance on X and Y axis between two |
| | distinct hosting machines i, j ∈ N:i ≠ j. |
| (v̅ᵢ^{X}, vᵢ^{Y}) | Pair of non-negative real variables representing |
| | the distance on X and Y axis between the |
| | pre-optimization and the post-optimization |
| | position of hosting machine i ∈ N. |
| (v̅ᵢ^{X}, vᵢ^{Y}) | Pair of non-negative real variables representing |
| | the distance on X and Y axis between the |
| | post-optimization position of hosting machine |
| | i ∈ N and the selected recharging hosting |
| | machine. |
| πₚᵢⱼ | Binary. Equal to 1 if routing path p ∈ P is |
| | selected to carry the flow of traffic demand |
| | (i, j) ∈ A_{z} of application z ∈ Z. |
| \hat{π}ₚᵢ | Binary. Equal to 1 if routing path p ∈ P is |
| | selected to carry the flow produced by the |
| | migration of virtualized element (application |
| | node) i ∈ V_{z} of application z ∈ Z. |
| π̅ₚᵢ | Binary. Equal to 1 if path p ∈ P is selected to |
| | carry the flow produced by the deployment of |
| | virtualized element (application node) i ∈ V_{z} of |
| | application z ∈ Z. |
| ω̅ᵢ^{z} | Binary. Equal to 1 if hosting machine i ∈ N is |
| | selected as virtual communication node to |
| | support application z ∈ Z. A virtual |
| | communication node carries traffic demands of |
| | an application z ∈ Z without hosting any of its |
| | virtualized elements. |
| Ξ̅ᵢ^{traw} | Non-negative, real. Amount of travel time |
| | necessary for the hosting machine i ∈ N |
| | hosting application node j ∈ V_{z} of application |
| | z ∈ Z to reach the corresponding DOA without |
| | exceeding its maximum speed . |
| ψᵢⱼ^{z} | Non-negative, real. Non-negative difference |
| | between Ξ̅ᵢ^{comp} + Ξ̅ᵢ^{traw} (application node j ∈ V_{z} |
| | of application z ∈ Z) and Ξᵢ (hosting machine |
| | i ∈ N). |
| μᵢᵣ^{z} | Non-negative, real. Amount of |
| | resource/capacity r ∈ R consumed by |
| | application z ∈ Z on hosting machine i ∈ N. |
| μᵢᵣₛ^{z} | Non-negative, real. Amount of |
| | resource/capacity r ∈ R consumed on hosting |
| | machine i ∈ N by those application nodes of |
| | type s ∈ S_{z} of z ∈ Z that can share resources |
| | with the other application nodes of the same |
| | type. |
| μ̅ᵢᵣₛ^{z} | Non-negative, real. Amount of |
| | resource/capacity r ∈ R consumed on hosting |
| | machine i ∈ N by those application nodes of |
| | type s ∈ S_{z} of z ∈ Z that cannot share resources |
| | with the other application nodes of the same |
| | type. |
| [symbol] | Binary. Equal to 1 if virtualized element |
| | (application node) i ∈ V_{z} of application z ∈ Z |
| | has concluded his blocking operations and it is |
| | co-placed with a fully active virtualized element |
| | (application node) j of the same type s ∈ S_{z}. |
| [symbol] | Binary. Equal to 1 if traffic demand (i, j) ∈ A_{z} |
| | should not be accounted when computing link |
| | capacity constraints because it involves source |
| | or destination application nodes with [symbol] |
| | parameters equal to 1. |
| [symbol] | Binary. Equal to 1 if virtualized element |
| | (application node) i ∈ V_{z} of application z ∈ Z |
| | has concluded his blocking operations and it is |
| | co-placed with any fully active application node |
| | of the same type s ∈ S_{z} that can share its |
| | resources. |
| [symbol] | Binary. Equal to 1 if virtualized element |
| | (application node) i ∈ V_{z} of application z ∈ Z is |
| | placed with any other nodes of the same type |
| | s ∈ S_{z} from which it can share the resources. |
| Θᵢⱼ | Binary. Equal to 1 if hosting machine i is |
| | currently assigned to hosting machine j ∈ \hat{N} as |
| | next recharging node. |
| Ξ̅ᵢ^{rech} | Non-negative, real. Total time required by |
| | hosting machine i ∈ N to move to the closest |
| | recharging station. |
| eᵢₕ | Binary. Equal to 1 if hosting machine i ∈ N lays |
| | within the boundaries of the wireless cell of |
| | hosting machine h ∈ Nᵢ. |
| eᵢⱼₕ | Binary. Equal to 1 if physical link (i, j) ∈ E lays |
| | within the boundaries of the wireless cell of |
| | hosting machine h ∈ Nᵢ. |

TABLE 3
Unit of measurements for each resource/capacity of set R.

| Resource ID | Unit of measurement |
|---|---|
| CPU | Number of vCPUs, non negative, real |
| GPU | Number of GPUs, non negative, integer |
| RAM | GB, non negative, real |
| HDD | GB, non negative, real |
| SSD | GB, non negative, real |
| RGB camera | Number of available RGB cameras |
| Infrared camera | Number of infrared cameras available at a time |
| Temp. sensor | Number of temperature sensors available at a time |

### 3 the Multi-Period Workload Generation

A collaborative application can be seen as a plurality of tasks (collection of workloads, application elements, application nodes, etc.) that may mutually interfere, interact, collaborate with each other. A user or a process aiming to run an application on top of a virtualization ready physical infrastructure powered by the distributed multi-period orchestrator must translate the given plurality of tasks into two virtual graphs G_{z}^{V} (V_{z}, A_{z}) and G_{z}^{T} (V_{z}, U_{z}), where each task is mapped to a specific virtualized element (multiple tasks can be packed within the same virtualized element). During this translation process, the relevant application parameters are configured, e.g., flavor of each virtualized element (type of Docker container, type of Ubuntu virtual machine, etc.), CPU and RAM requirements and so on.

This operation can be naturally done through a User Interface (UI) of:
a web-based application,
a mobile application,
any dedicated software running on a Windows, MAC or Linux computer.

The multi-period workload generation component connected to the UI must have a network connection with at least one of the hosting machine of the virtualization ready physical infrastructure; if at least one hosting machine of the virtualization ready physical infrastructure has global internet connectivity, the multi-period workload generation component can be run somewhere in the cloud, otherwise it must run on any device locally connected to at least one hosting machine of the virtualization ready physical infrastructure, as well as directly on one of the hosting machines. In the latter case, the interaction between the user and the distributed multi-period orchestrator is enabled by a communication link provided by the telecommunication application described in Section 12.

In principle, any collaborative application (plurality of tasks) can be translated into the corresponding pair of G_{z}^{V} (V_{z}, A_{z}) and G_{z}^{T} (V_{z}, U_{z}) graphs.

Examples of such collaborative applications include:
Collaborative home automation applications.
Autonomous UAV-powered 3D mapping missions.
Autonomous UAV-powered surveillance missions.
Collaborative Camera-powered surveillance applications.
Autonomous road-light management applications.

The multi-period workload generation process allows the distributed multi-period orchestrator to manage a highly heterogeneous set of applications (plurality of tasks). In particular, let us put the emphasis on the heterogeneity in terms of mobility requirements:
Static application (plurality of tasks): all the virtualized elements of graph G_{z}^{V} (V_{z}, A_{z}) can be hosted on static/fixed hosting machines.
Hybrid application (plurality of tasks): at least one virtualized element of graph G_{z}^{V} (V_{z}, A_{z}) requires to be hosted on mobile (capable of changing position) hosting machine.
Mobile application (plurality of tasks): all the virtualized elements of graph G_{z}^{V} (V_{z}, A_{z}) must be hosted be mobile (capable of changing position) hosting machines.

### 3.1 Virtualized Element Characterization

As already mentioned, during the multi-period workload generation process, each virtualized element that will represent one or more application tasks from the original plurality of tasks must be characterized by the corresponding set of parameters. These parameters will later allow the distributed multi-period orchestror to optimally place each virtualized element on top of the virtualization ready physical infrastructure. Here follows the detailed list of these parameters:
V_{z}: Set of virtualized elements (application nodes); note that when designing the application graph the rule of thumbs is to aggregate as many possible applications functions (tasks from the plurality of tasks) into a single virtualized element.
ρᵢₖᵣ: Binary parameter, equal to 1 if virtualized element (application node) i is compatible with configuration k∈K^{r} for resource r∈R; for instance, a virtualized element may be compatible with a hosting machine of configuration k∈K^{T} in terms of CPUs (r∈R∪{CPU}) offering single cores with an operating frequency of at least 1.4 GHz.
ϕᵢᵣ^{z}: Non-negative real parameter, amount of resource r∈R demanded by virtualized element i∈V_{z} of application z∈Z; for instance, being r∈R∪{RAM}, the virtualized element (application node) may ask for 512 MB of memory.
\hat{δ}ᵢ^{z}: Non-negative real parameter, minimum bandwidth to be allocated for the migration of virtualized element (application node) i∈V_{z} of application z∈Z and satisfy its maximum migration latency requirement, e.g., 100 mbps.
δ̅ᵢ^{z}: Non-negative real parameter, minimum bandwidth to be allocated for the deployment of virtualized element (application node) i∈V_{z} of application z∈Z and satisfy its maximum deployment latency requirement, e.g., 100 mbps.
M_{iz}^{down}: Non negative real parameter, maximum down-time duration allowed by virtualized element (application node) i∈V_{z} of application z∈Z in case a migration is required.
(Aᵢ^{DOE}, Aᵢ^{DOW}, Aᵢ^{DON}, Aᵢ^{DOS}): 4-object tuple of non-negative real parameters (non-negative because we consider only the positive quadrant of the Cartesian space), representing the East, West, North, South boundaries of the rectangular DOA of virtualized element (application node) i of application z∈Z.
(Aᵢ^{FOE}, Aᵢ^{FOW}, Aᵢ^{FON}, Aᵢ^{FOS}): 4-object tuple of non-negative real parameters (non-negative because we consider only the positive quadrant of the Cartesian space), representing the East, West, North, South boundaries of the rectangular FOA of virtualized element (application node) i of application z∈Z.
χᵢⱼ^{r}: Binary parameter, equal to 1 if virtualized element (application node) i∈V_{z} of application z∈Z cannot be activated simultaneously with a second virtualized element (application node) j∈Vz of the same application, when both elements are assigned to the same hosting machine.
χ̅ᵢⱼ^{z}: binary parameter, equal to 1 if virtualized elements (application nodes) i, j∈V_{z}: i≠j of application z∈Z have to be run simultaneously.
\hat{χ}ᵢⱼ^{z}: binary parameters, equal to 1 if virtualized element (application node) i∈V_{z} of application z∈Z must be placed to allow the placement of a second virtualized element (application node) j∈V_{z}.
κ̅ᵢ^{z}: Non negative real parameter, minimum reputation value demanded by virtualized element (application node) i∈V_{z} of application z∈Z.
Ξ̅ⱼ^{comp}: Non-negative real parameter, amount of computing time explicitly requested by virtualized element (application node) j∈V_{z} of application z∈Z.
ψ̅ᵢ^{z}: Binary parameter equal to 1 if virtualized element (application node) i∈V_{z} of application z∈Z can accept to be placed on a hosting machine which may leave the virtualization ready physical infrastructure before the virtualized element itself has concluded its operation
Σᵢⱼ^{z}: Binary parameter equal to 1 if virtualized element (application node) i∈V_{z} of application z∈Z has to placed on the same hosting machine hosting a second virtualized element (application node) j∈V_{z}\{i} of the same application.
βᵢ: Binary parameter equal to 1 if virtualized element (application node) i∈V_{z} of application z∈Z must be activated at this round of placement, otherwise the application is considered refused (not placed).
β̅_{z}: Non-negative real parameter, minimum number of virtualized elements (application nodes) of application z∈Z to be placed at this round of placement, otherwise the application is considered refused.
ζ_{z}: Non-negative real parameter, penalty cost for refusing the placement of application z∈Z. This parameter represents the priority level of a given application.
bᵢ^{z}: Non-negative real parameter, penalty cost for migrating the virtualized element (application node) i∈V_{z} of application z∈Z. This parameter represents the priority level of a virtualized element (application node).
S_{z}: Set of types of virtualized elements (application nodes) used in application z∈Z; All the application nodes of the same type s∈S_{z} can share the same set of host resources when placed on the same hosting machine.
q̅ᵢₛ^{z}: Binary parameter equal to 1 if virtualized element (application node) i∈V_{z} of application z∈Z can share the resources of other virtualized elements (application nodes) of the same application z∈Z when they are of the same type.
vᵢₛ^{z}: Binary parameter equal to 1 if virtualized element (application node) i∈V_{z} of application z∈Z is of type s∈S_{z}.
A_{z}: Set of traffic demands of application z∈Z.
δᵢⱼ^{z}: Non-negative real parameter, minimum bandwidth to be allocated to satisfy the communication requirements of traffic demand (i,j)∈A_{z} of application z∈Z, e.g., 10 mbps.
Δᵢⱼ^{z}: Non-negative real parameter. Maximum network latency accepted by traffic demand (i, j)∈A_{z} of application z∈Z.

It is worth pointing out that, besides configuring virtualized element parameters, the user may be also requested to:
Select the desired reliability level H to allow the orchestrator to trigger the graph transformation described in Section 3.2.
Select the desired network reliability level A to demand that A routing paths are activated per traffic demand.
Flag the option allowing to separate storage and computing components and trigger the graph transformation described in Section 3.3).

Furthermore, note that if a given application (multi-period workload) has just best-effort QoS requirements, it means that can be placed on any kind of hosting machines without accounting for their availability periods, as well as for the amount of bandwidth reserved between the multiple virtualized elements. In this case, it would be enough to create an application graph with an empty set A_{z}, and corresponding parameters Ξ̅^{comp}=0 and ψ̅=1. This virtualized elements can be thus placed on any nodes, also the busy ones or those whose movements are not under control.

### 3.2 Resilience Awareness

To minimize the negative effects of hardware failures, H copies of each virtualized elements are placed on different physical servers, and a certain amount of bandwidth is reserved between original and replicated virtual elements to support the data flow generated to keep the latter up to date.

This process can be naturally modeled through a transformation of the virtual graph G^{v} (V, A) similar to that illustrated in Section 3.3. As shown in FIG. 4, for each virtualized element i∈V_{z} of application v∈V, H virtual nodes hⱼ Vⱼ ∈{1 . . . Π} (with the same resource requirements ϕ) are created and connected to i by two backup traffic demands (i, hⱼ) and (hⱼ, i)∈A_{z}.

Note that replicated virtualized elements are not supposed to consume any resource; however the proper amount of computing/storage resources and physical capacities (the same of the original element) has to be reserved to guarantee that the requirements will be respected in case of failure of the original virtualized element.

### 3.3 Storage Splitting Transformation

If storage resources are allowed to be allocated on different hosting machines with respect to those serving the computing resources (see for instance Amazon Elastic Bock Store [1]), the application graph is modified as follows (see also FIG. 5):
Each virtualized element i∈V_{z} of application z∈Z is split among two new different virtualized elements j and h, with:
   j being a computing nodes with
      Parameters ϕⱼᵣ forced to 0 ∀r∈R∩{SSD,HDD} (no storage space required),
      ϕⱼᵣ=ϕᵢᵣ∀r∈R∩{CPU,GPU,RAM}, i.e., traditional computing, graphical processing and RAM resources unvaried.
      ρⱼₖᵣ=ρᵢₖᵣ ∀k∈K^{r}, ∀r∈R, i.e., all compatibility requirements unvaried.
   h being a storage nodes with
      Parameters ϕₕᵣ forced to 0 ∀r∈R∩{CPU,GPU,RAM} (no computing nor memory resources required),
      ϕₕᵣ=ϕᵢᵣ∀r∈R∩{HDD,SSD}, i.e. slow and high speed computing space resource requirements unvaried,
      Parameters ρⱼₖᵣ forced to 1 ∀k∈K^{r}, ∀r∈R, i.e., all compatibility requirements are ignored;
An additional bidirectional traffic demand (j, h) is added to the traffic demand set A_{z} of application z∈Z to account for the network bandwidth δⱼₕ^{z} required to guarantee the demanded data rate transfer for both read and write operations on the storage node.
   3.4 Interaction with the Other Modules

Once a plurality of tasks belonging to the same application is fully translated into the corresponding pair of graphs representing a multi-period workload, the whole set of parameters that we just described is transferred to the distributed multi-period orchestration instance of at least one hosting machine. The same process is repeated whenever the user modifies the parameters of a multi-period workload already placed on top of the virtualization ready physical infrastructure.

During the life cycle of the application (multi-period workload), the hosting machine that originally received the placement request will keep updating the originating multi-period workload generation module about the state of the virtualized elements, e.g., average performance, IDs of queued virtualized elements, position of involved hosting machines, etc.

The continuous flow of application-related information between these two modules allows to exploit the multi-period nature of the distributed orchestration system to generate new virtualized elements (application nodes) in real-time: this mechanism is driven by the real-time output of the virtualized elements already running. Section 3.5 discloses an example of how real-time virtualized element (workload) generation can be leveraged in the context of a 3D mapping application powered by UAVs.

3.5 an Example: Autonomous 3D Mapping with UAVs

An autonomous 3D mapping mission can be characterized by the three-stage (multi-period) work-flow represented in FIG. 6:
1. Stage 1: Photo collection.
2. Stage 2: Computation of optimal 3D reconstruction configuration.
3. Stage 3: Collaborative 3D reconstruction.

This 3-stage workload has to be further extended to generate the corresponding pair of virtual graphs G^{V} (V_{z}, A_{z}) and G_{z}^{T} (V_{z}, U_{z}), shown in FIG. 7, ready to be managed by the distributed multi-period orchestrator. The various elements illustrated in FIG. 7 are described below:
Top graph G^{V} (V_{z}, A_{z}), bidirectional black arrows: standard traffic demands belonging to A_{z}.
Top graph G^{V} (V_{z}, A_{z}), bidirectional blue dotted arrows: storage traffic demands belonging to A_{z}.
Top graph G^{V} (V_{z}, A_{z}) and bottom graph G^{T} (V_{z}, U_{z}), red rectangles: special types of application node belonging to S_{z}.
Bottom graph G^{T} (V_{z}, U_{z}), bidirectional dotted black arrows: simultaneity relationships for pair of application nodes characterized by x equal to 1.
Bottom graph G^{T} (V_{z}, U_{z}), bidirectional dashed black arrows: serialization relationships on the same physical machine for pairs of application nodes characterized by χᵢⱼ^{z} equal to 1.
Bottom graph G^{T} (V_{z}, U_{z}), bidirectional red arrows: global serialization relationships for pairs of application nodes characterized by \hat{χ}ᵢⱼ^{z} equal to 1.

It is worth pointing out that a further transformation (following the logic described in Section 3.3) may be performed to graphs G^{V} (V_{z}, A_{z}) and G_{z}^{T} (V_{z}, U_{z}) to separate computing and storage application nodes (see FIG. 8). Note that, in FIG. 8, the bidirectional blue arrows represent the storage traffic demands. In a similar way, graphs G^{V} (V_{z}, A_{z}) and G_{z}^{T} (V_{z}, U_{z}) could be transformed into their corresponding Π-reliable version by following the procedure described in Section 3.2.

To conclude, note that the multi-period nature of the new distributed multi-period orchestration system allows the application designer to run applications (multi-period workloads) where a part of the virtualized elements (application nodes) can be generated in real-time in a on-demand fashion, according to the output of the virtualized elements (application nodes) already running. For instance, in our 3D mapping example, the number of 3D processing virtualized elements (application nodes) may be dynamically computed by the optimization algorithm run inside the 3D optimizer virtualized elements; this algorithm is designed to decide how many sub-regions have to be reconstructed in parallel to minimize 3D reconstruction computing times. Otherwise, by deciding the number 3D processing application nodes in advance, the 3D optimizer virtualized elements will simply decide which of these 3D processing nodes should be activated. The new multi-period orchestration scheme grant the application designers/owners with a substantial degree of freedom during the application development/planning stage.

### 4 the Task Assignment Module

The task assignment module is the core of the distributed multi-period orchestrator. It is responsible for computing the multi-period placement solution describing how to map each virtualized element on top of a hosting machine while optimizing one or multiple given criteria and respecting a given set of system constraints. The main blocks of the task assignment module consist in two strongly tied components:
A mathematical formulation of the multi-period workload placement problem.
A collaborative multi-period placement algorithm to solve, in real-time, the multi-period workload placement problem.

It will be appreciated that the task assignment module is also referred to as the distributed multi-period orchestrator.

### 4.1 the Multi-Period Workload Placement Problem

The multi-period workload placement problem is the mathematical representation of the orchestration process carried out to virtualize multiple multi-period workloads on top of the available virtualization ready physical infrastructure. The optimization problem is obtained by leveraging all the definitions previously presented in Table 2.

To summarize, the multi-period workload placement problem is presented below:

Given
A graph G^{P} (N, E) made by nodes and arcs represented as a set N of hosting machines (nodes) and a set E of physical communication links (arcs), where:
   Each hosting machine i∈N:
      Offers an amount ωᵢᵣ of resource r∈R
      Is run with hardware configuration k∈K^{r} for resource r∈R if binary parameter ηᵢₖᵣ is equal to 1.
      Consumes ϵᵢ Watt of energy, once activated.
      Is characterized by a overall wireless cell throughput of c̅ᵢ (if equipped with at least one wireless communication interface);
   Each physical link (i, j)∈E:
      Is characterized by a step-wise throughput-distance function described by the set of pieces h∈H^{ij} corresponding to link capacity values cᵢⱼₕ and by non-negative distance parameters lₕ⁺ and lₕ⁻; For wired links, the step-wise throughput-distance function is composed by just one horizontal piece.
      May belong to multiple wireless cells, and thus to multiple sets Eᵢ (if established by wireless network interfaces);
A set P of routing paths, where each path p E P is characterized by a sequence of links of E that starts from source hosting machine oₚ and terminates in destination hosting machine tₚ.
A set Z̅⊂Z of multi-period workloads (applications) already placed (mapped) on top of graph G^{P} (N, E), each one represented by the dedicated graphs G_{z}^{V} (V_{z}, A_{z}) and G_{z}^{T} (V_{z}, U_{z}) already described in Section 3;
A second set \hat{Z}⊂Z of multi-period workloads (applications) demanding to be hosted on top of graph G^{P} (N, E), each one represented by the dedicated graphs G_{z}^{V} (V_{z}, A_{z}) and G_{z}^{T} (V_{z}, U_{z}) already described in Section 3;

The distributed multi-period orchestrator must decide
Which virtualized element (application node) to host on each hosting machine and which virtualized element (application node) to put in the waiting queue—xᵢⱼ^{z} and yᵢⱼₕₛ^{z} binary variables;
Which application to refuse in case not enough resources are available—g_{z} binary variables;
Which position should be assigned to each mobile node—λᵢ^{X}, λᵢ^{Y}, νᵢⱼ^{X}, νᵢⱼ^{Y}, ν̅ᵢ^{X}, ν̅ᵢ^{Y};
Which hosting machine should be activated—vᵢ binary variables;
Which routing path to select to serve traffic demand between two virtualized elements—πₚᵢⱼ, \hat{π}ₚᵢ, π̅ₚᵢ and \dot{f}ᵢⱼ^{z} binary variables, as well as fᵢⱼ, \hat{f}ᵢⱼ, f̅ᵢⱼ, fᵢⱼ^{z}, \hat{f}ᵢⱼ^{z}, f̅ᵢⱼ^{z}, c̅ᵢ non-negative real variables.
Which hosting machine should act as auxiliary network maintainer node for a given application—binary variables ω̅ᵢ^{z};
Which virtualized element already placed on a active host machine to migrate to a different hosting machine, by considering both network-based and physical migrations—wᵢⱼ^{z}, w̅ᵢⱼ^{z} and ŵᵢⱼ^{z} binary variables;

To minimize eight cost components
1. Overall energy consumption—vᵢ binary variables.
2. Overall link delay costs—τᵢⱼ non-negative real variables.
3. Overall resource utilization costs—uᵢᵣ non-negative real variables.
4. Overall refusal costs—g_{z} binary variables.
5. Overall migration costs—wᵢⱼ^{z} binary variables.
6. Overall wireless cell congestion costs—τᵢ non-negative real variables.
7. Overall node movements—ν̅ᵢ^{X} and ν̅ᵢ^{Y} non-negative real variables.
8. Overall uncertainty costs—ψᵢⱼ^{z} non-negative real variables.

While respecting multiple problem constraints, including those to
Respect precedence/simultaneity/serialization/parallelization requirements.
Respect network capacities while satisfying network demand requirements.
Respect resource availability while satisfying resource demand requirements.
Respect geo-location and mobility limitations.
Respect reputation levels.
Respect priority requests.
etc.

It will be appreciated that some problem variables do not represent direct decisions of the distributed multi-period orchestrator. They are instead used as auxiliary variables to quantify objective function components and evaluate the secondary effects produced by the main decision variables. These variables can be found in Table 2.

The multi-period workload placement problem can be formally expressed by the following Mixed Integer Non-linear Programming (MINP) formulation, which is presented one group of equations at a time to make place for the corresponding descriptions:

### Multi Objective Function

The multi-objective function is made by eight different cost minimization components:
1. Overall energy consumption.
2. Overall link utilization cost (it can be interpreted also as a monetary price).
3. Overall resource utilization cost (it can be interpreted also as a monetary price).
4. Overall refusal penalty cost. Both the refusal of an application, as well of the single virtualized elements (application nodes) are accounted for.
5. Overall migration costs. It will be appreciated that opportunistic physical migrations have a lower cost with respect to active physical migrations.
6. Overall wireless cell utilization cost.
7. Overall hosting machine movement cost.
8. Overall uncertainty cost.

$$min ( {α}_{1} {\sum }_{i ∈ N} {ϵ}_{i} {υ}_{i} + {α}_{2} {\sum }_{( i , j ) ∈ E} {τ}_{ij} + {α}_{3} {{\sum }_{i ∈ N}}_{r ∈ R} {u}_{ir} + {α}_{4} {\sum }_{z ∈ Z} [ {Ϛ}_{z} ( 1 - {ℊ}_{z} ) + {\sum }_{i ∈ {V}_{z}} ( 1 - {\sum }_{j ∈ N} {x}_{ij}^{z} ) ] + {α}_{5} {{\sum }_{i ∈ V}}_{z ∈ {Z}^{z}} {\sum }_{j ∈ N} {b}_{i}^{z} [ {w}_{ij}^{z} + {\overline{w}}_{ij}^{z} + \frac{{\hat{w}}_{ij}^{z}}{2} ] + {α}_{6} {\sum }_{i ∈ N} {τ}_{i} + {α}_{7} {\sum }_{i ∈ N} [ {\overline{v}}_{i}^{X} + {\overline{v}}_{i}^{Y} ] + {α}_{8} {{{\sum }_{i ∈ N}}_{z ∈ Z}}_{j ∈ {V}_{z}} {ψ}_{ij}^{z} ) . \qquad ( 1 )$$

### Basic Placement Rules

The first group of constraints to be added concerns the basic placement rules for the application nodes:

$$\begin{matrix}{\sum }_{j ∈ N} {x}_{ij}^{z} \leq 1 & ∀ z ∈ Z , i ∈ {V}_{z} ,\end{matrix} \qquad ( 2 )$$

$$\begin{matrix}{x}_{ij}^{z} \leq {\underline{x}}_{ij}^{z} + {γ}_{j} & ∀ z ∈ Z , i ∈ {V}_{z} , j ∈ N ,\end{matrix} \qquad ( 3 )$$

$$\begin{matrix}{x}_{ij}^{z} \leq [ {\sum }_{k ∈ {K}^{r}} ( {η}_{jkr} {ρ}_{ikr} ) ] {υ}_{j} & ∀ z ∈ Z , i ∈ {V}_{z} , j ∈ N , r ∈ R ,\end{matrix} \qquad ( 4 )$$

$$\begin{matrix}{\sum }_{j ∈ N} {x}_{ij}^{z} \geq {ℊ}_{z} {\sum }_{j ∈ N} {\underline{x}}_{ij}^{z} & ∀ z ∈ Z , i ∈ {V}_{z} ,\end{matrix} \qquad ( 5 )$$

$$\begin{matrix}{\sum }_{j ∈ N} {x}_{ij}^{z} \geq {β}_{i} - ( 1 - {ℊ}_{z} ) & ∀ z ∈ Z , i ∈ {V}_{z} ,\end{matrix} \qquad ( 6 )$$

$$\begin{matrix}{\overline{β}}_{z} {ℊ}_{z} \leq {\sum }_{i ∈ {V}_{z}} {\sum }_{j ∈ N} {x}_{ij}^{z} & ∀ z ∈ Z ,\end{matrix} \qquad ( 7 )$$

$$\begin{matrix}{\hat{X}}_{ji}^{z} {x}_{in}^{z} \leq {\sum }_{m ∈ N} {x}_{jm}^{z} & ∀ z ∈ Z , i ∈ {V}_{z} , j ∈ {V}_{z} \backslash \{ i \} ,\end{matrix} \qquad ( 8 )$$

$$\begin{matrix}{\overline{X}}_{ij}^{z} ( {\sum }_{n ∈ N} {x}_{in}^{z} - {\sum }_{m ∈ N} {x}_{jm}^{z} ) = 0 & ∀ z ∈ Z , i ∈ {V}_{z} , j ∈ {V}_{z} \backslash \{ i \} ,\end{matrix} \qquad ( 9 )$$

$$\begin{matrix}1 - ( 1 - {q}_{in}^{z} ) {X}_{ij}^{z} {x}_{in} \geq {x}_{jn}^{z} & ∀ z ∈ Z , i ∈ {V}_{z} , j ∈ {V}_{z} \backslash \{ i \} , n ∈ N ,\end{matrix} \qquad ( 10 )$$

$$\begin{matrix}{\sum }_{ij} ( {x}_{in}^{z} - {x}_{jn}^{z} ) = 0 & ∀ z ∈ Z , i ∈ {V}_{z} , j ∈ {V}_{z} \backslash \{ i \} ,\end{matrix} \qquad ( 11 )$$

$$\begin{matrix}{\overline{y}}_{ijn}^{z} \geq {x}_{in}^{z} + {x}_{jn}^{z} - 1 & ∀ z ∈ Z , i ∈ {V}_{z} , j ∈ {V}_{z} \backslash \{ i \} , n ∈ N ,\end{matrix} \qquad ( 12 )$$

$$\begin{matrix}{\overline{y}}_{ijn}^{z} \leq {x}_{in}^{z} & ∀ z ∈ Z , i ∈ {V}_{z} , j ∈ {V}_{z} \backslash \{ i \} , n ∈ N ,\end{matrix} \qquad ( 13 )$$

$$\begin{matrix}{\overline{y}}_{ijn}^{z} \leq {x}_{jn}^{z} & ∀ z ∈ Z , i ∈ {V}_{z} , j ∈ {V}_{z} \backslash \{ i \} , n ∈ N ,\end{matrix} \qquad ( 14 )$$

$$\begin{matrix}{x}_{ij}^{z} ∈ \{ 0 , 1 \} & ∀ z ∈ Z , i ∈ {V}_{z} , j ∈ N ,\end{matrix} \qquad ( 15 )$$

$$\begin{matrix}{\overline{y}}_{ijn}^{z} ∈ \{ 0 , 1 \} & ∀ z ∈ Z , i ∈ {V}_{z} , j ∈ {V}_{z} \backslash \{ i \} , n ∈ N ,\end{matrix} \qquad ( 16 )$$

$$\begin{matrix}{υ}_{i} ∈ \{ 0 , 1 \} & ∀ i ∈ N ,\end{matrix} \qquad ( 17 )$$

$$\begin{matrix}{ℊ}_{z} ∈ \{ 0 , 1 \} & ∀ z ∈ Z .\end{matrix} \qquad ( 18 )$$

Equation (2) prevents the distributed multi-period orchestrator from placing an application node multiple times, while Equation (5) prevents the distributed multi-period orchestrator from removing a virtualized element (application node) already placed during previous optimization rounds. According to Equation (4), a hosting machine must be activated to host any virtualized element (application node), as well as the distributed multi-period orchestrator must respect the compatibility requirements of the hosted virtualized element (ρ and η parameters). Equation (3) states that a virtualized element (application node) i∈V_{z} of application z∈Z can be placed on hosting machine i∈N only if this latter is not busy, or if it is already placed on it. A busy hosting machine is typically a moving hosting machine in the process of performing a specific task of a virtualized element as well as a task in support of another virtualized element (e.g., move to improve network performance). According to Equation (6), an application z∈Z is considered placed (g_{z}=1) if and only if its mandatory virtualized elements (application nodes) i∈V_{z}|βᵢ=1 are placed during the current optimization round. Similarly, Equation (7) states that an application is considered placed if and only at least β̅_{z} of its virtualized elements (application nodes) can be placed during the current optimization round. Equation (8) instructs the distributed multi-period orchestrator to respect precedence relationship: being i, j∈V_{z}|i≠j two virtualized elements (application nodes) of application z∈Z characterized by \hat{χ}ᵢⱼ^{z}=1, virtualized element (application node) j can be placed at this optimization round if and only if also virtualized element (application node) i is successfully placed. Slightly different is instead the meaning of Equation (9), which forces two virtualized elements (application nodes) i, j∈V_{z}|i≠j of the same application z∈Z that are characterized by χ̅ᵢⱼ^{z}=χ̅ⱼᵢ^{z}=1 to be placed at the same optimization round (even on different hosting machines). If two virtualized elements (application nodes) i, j∈V_{z}∈i≠j of the same application z∈Z cannot be run together when co-placed on the same machine χᵢⱼ^{z}=χⱼᵢ^{z}=1, Eq. (10) is used to allow the co-placement of those virtualized elements (application nodes) only in case one of them has concluded its operations. Finally Equation (11) forces certain pairs of virtualized elements (application nodes) i, j∈V_{z}|i≠j of application z∈Z characterized by Σᵢⱼ=1 to be co-placed. We define here also new co-placement constraints (12)-(14) necessary to define variables y, since these variables will be exploited later for resource availability constraints. Finally, Equations (15)-(18) define the domain of basic placement variables x, co-placement variables y̅, node activation variables v and application placement variables g.

### Resource Allocation

To correctly manage the corresponding set of hosting machines, the distributed multi-period orchestrator must guarantee that enough resources are available on each hosting machine to host the desired subset of virtualized elements (application nodes). The distributed multi-period orchestrator must also consider that some virtualized elements (application nodes) may be able to share the same amount of resources when placed on the same hosting machine. The following group of constraints is introduced to correctly manage the physical resources:

$$\begin{matrix}{μ}_{irs}^{z} \geq {\overline{q}}_{js}^{z} {υ}_{js}^{z} {ϕ}_{jr} {x}_{ji}^{z} & ∀ z ∈ Z , s ∈ {S}_{z} , j ∈ {V}_{z} , i ∈ N , r ∈ R ,\end{matrix} \qquad ( 19 )$$

$$\begin{matrix}{\overline{μ}}_{irs}^{z} \geq [ {\sum }_{j ∈ {V}_{z}} ( 1 - {\overline{q}}_{js}^{z} ) {υ}_{js}^{z} {ϕ}_{jr} {x}_{ji}^{z} ] & ∀ z ∈ Z , s ∈ {S}_{z} , j ∈ {V}_{z} , i ∈ N , r ∈ R ,\end{matrix} \qquad ( 20 )$$

$$\begin{matrix}{μ}_{ir}^{z} \geq {\sum }_{s ∈ {S}_{z}} [ {μ}_{irs}^{z} + {\overline{μ}}_{irs}^{z} ] & ∀ z ∈ Z , r ∈ R , i ∈ N ,\end{matrix} \qquad ( 21 )$$

$$\begin{matrix}{\sum }_{z ∈ Z} {μ}_{ir}^{z} \leq {Ω}_{r} {ω}_{ir} & ∀ i ∈ N , r ∈ R ,\end{matrix} \qquad ( 22 )$$

$$\begin{matrix}{u}_{ir} \geq {Φ}_{r} ( \frac{{\sum }_{z ∈ Z} {μ}_{ir}^{z}}{{ω}_{ir}} ) & ∀ i ∈ N , r ∈ R ,\end{matrix} \qquad ( 23 )$$

$$\begin{matrix}{Υ}_{ij}^{z} \leq {\sum }_{s ∈ {\overline{S}}_{z}} \{ {\overline{υ}}_{is}^{z} {\overline{υ}}_{js}^{z} {\overline{q}}_{is}^{z} {\overline{q}}_{js}^{z} {\sum }_{n ∈ N} [ {\overline{y}}_{ijn}^{z} {q}_{in}^{z} ] \} & ∀ z ∈ Z , i ∈ {V}_{z} , j ∈ {V}_{z} \backslash \{ i \} ,\end{matrix} \qquad ( 24 )$$

$$\begin{matrix}{Υ}_{ij}^{z} \geq {\sum }_{s ∈ {\overline{S}}_{z}} \{ {\overline{υ}}_{is}^{z} {\overline{υ}}_{js}^{z} {\overline{q}}_{is}^{z} {\overline{q}}_{js}^{z} {\overline{y}}_{ijn}^{z} {q}_{in}^{z} \} & ∀ z ∈ Z , i ∈ {V}_{z} , j ∈ {V}_{z} \backslash \{ i \} , n ∈ N ,\end{matrix} \qquad ( 25 )$$

$$\begin{matrix}{Υ}_{i}^{z} \leq {\sum }_{j ∈ {V}_{z}} {Υ}_{ij}^{z} & ∀ z ∈ Z , i ∈ {V}_{z} ,\end{matrix} \qquad ( 26 )$$

$$\begin{matrix}{\hat{Υ}}_{i}^{z} \leq {\sum }_{j ∈ {V}_{z}} {Υ}_{ji}^{z} & ∀ z ∈ Z , i ∈ {V}_{z} ,\end{matrix} \qquad ( 27 )$$

$$\begin{matrix}{\overline{Υ}}_{ij}^{z} \leq {\sum }_{n ∈ {V}_{z}} {Υ}_{in}^{z} & ∀ z ∈ Z , ( i , j ) ∈ {A}_{z} ,\end{matrix} \qquad ( 28 )$$

$$\begin{matrix}{\overline{Υ}}_{ij}^{z} \leq {\sum }_{n ∈ {V}_{z}} {Υ}_{jn}^{z} & ∀ z ∈ Z , ( i , j ) ∈ {A}_{z} ,\end{matrix} \qquad ( 29 )$$

$$\begin{matrix}{μ}_{ir}^{z} , {μ}_{irs}^{z} , {\overline{μ}}_{irs}^{z} \geq 0 & ∀ z ∈ Z , s ∈ {S}_{z} , i ∈ N , r ∈ R ,\end{matrix} \qquad ( 30 )$$

$$\begin{matrix}{u}_{ir} \geq 0 & ∀ i ∈ N , r ∈ R ,\end{matrix} \qquad ( 31 )$$

$$\begin{matrix}{Υ}_{ij}^{z} ∈ \{ 0 , 1 \} & ∀ z ∈ Z , i ∈ {V}_{z} , j ∈ {V}_{z} \backslash \{ i \} ,\end{matrix} \qquad ( 32 )$$

$$\begin{matrix}{Υ}_{i}^{z} , {\hat{Υ}}_{i}^{z} ∈ \{ 0 , 1 \} & ∀ z ∈ Z , i ∈ {V}_{z} ,\end{matrix} \qquad ( 33 )$$

$$\begin{matrix}{\overline{Υ}}_{ij}^{z} ∈ \{ 0 , 1 \} & ∀ z ∈ Z , ( i , j ) ∈ {A}_{z} .\end{matrix} \qquad ( 34 )$$

Equations (19)-(22) guarantee that hosting machine resources are not consumed beyond availability, considering that some virtualized elements (those belonging to the same application type S_{z} and capable of sharing resources, see parameter q̅) may share some of their resources: the same principle is also considered by resource utilization cost constraint (23), which is used to evaluate the resource utilization cost on each hosting machine. Equations (24)-(27) are used to correctly compute the colocation variables Υᵢⱼ^{z}, which are equal to 1 if virtualized element (application node) i∈V_{z} of application z∈Z has concluded his blocking operations and it is co-placed with a fully active virtualized element (application node) j of the same type s∈S_{z} that can share its resources. Finally, Equations (28)-(29) are used to determine the traffic demands whose traffic should not be considered due to co-placement with other active virtualized elements (application nodes) of the same type. For sake of completeness, Equations (30)-(34) define the domains of the variables just introduced.

### Geo-Location Constraints

All the constraints related to hosting machine position and the corresponding positioning rules to be respected are now introduced:

νᵢⱼ^{X}≥λᵢ^{X}−λⱼ^{X} ∀(i,j)∈E, (35)

νᵢⱼ^{X}≥−λᵢ^{X}+λⱼ^{X} ∀(i,j)∈E, (36)

νᵢⱼ^{Y}≥λᵢ^{Y}−λⱼ^{Y} ∀(i,j)∈E, (37)

νᵢⱼ^{Y}≥−λᵢ^{Y}+λⱼ^{X} ∀(i,j)∈E, (38)

ν̅ᵢ^{X}≥λᵢ^{X}−λᵢ^{X} ∀i∈N, (39)

ν̅ᵢ^{X}≥−λᵢ^{X}+λᵢ^{X} ∀i∈N, (40)

ν̅ᵢ^{Y}≥λᵢ^{Y}−λᵢ^{Y} ∀i∈N, (41)

ν̅ᵢ^{Y}≥−λᵢ^{Y}−λᵢ^{Y} ∀i∈N, (42)

xᵢⱼ^{z}≤Ā_{zij}^{FO}∀z∈Z,i∈V_{z},j∈N, (43)

λⱼ^{Y}≤Aᵢ^{DON}+\hat{M}(1−xᵢⱼ^{z}) ∀z∈Z,i∈V_{z},j∈N, (44)

λⱼ^{Y}≥Aᵢ^{DOS}−\hat{M}(1−xᵢⱼ^{z}) ∀z∈Z,i∈V_{z},j∈N, (45)

λⱼ^{X}≤Aᵢ^{DOE}+\hat{M}(1−xᵢⱼ^{z}) ∀z∈Z,i∈V_{z},j∈N, (46)

λⱼ^{X}≥Aᵢ^{DOW}−\hat{M}(1−xᵢⱼ^{z}) ∀z∈Z,i∈V_{z},j∈N, (47)

λᵢ^{Y}≤Aᵢ^{AON} ∀i∈N, (48)

λᵢ^{Y}≥Aᵢ^{AOS} ∀i∈N, (49)

λᵢ^{X}≤Aᵢ^{AOE} ∀i∈N, (50)

λᵢ^{X}≥Aᵢ^{AOW} ∀i∈N, (51)

λᵢ^{X},λᵢ^{Y}∈ [symbol] ∀i∈N, (52)

νᵢⱼ^{X},νᵢⱼ^{Y}≥0 ∀(i,j)∈E, (53)

ν̅ᵢ^{X},ν̅ᵢ^{Y}≥0 ∀i∈N. (54)

(55)

Equations (35)-(38) allow to compute the X-Y distances between two different hosting machines i, j∈N|i≠j. Similarly, Equations (39)-(42) are used to estimate the X-Y distances between pre-optimization and post-optimization positions of the same hosting machine i∈N. Equation (43) allows a virtualized element (application node) i∈V_{z} of application z∈Z to be placed only on top of hosting machines j∈N laying within the FOA defined by the application during the workload generation phase. Equations (44)-(47) force each hosting machine to move toward the position (a valid set of coordinated within the application DOA) requested by the hosted virtualized element (application node). Thus, a hosting machine cannot host, at the same time, two different virtualized elements (application nodes) related to not overlapping DOAs. On the other side, Equations (44)-(47) prevent a hosting machine from moving beyond the boundaries of its rectangular AOA. Remind that these equations can be easily modified to account for any area shapes. For sake of completeness, Equations (52)(54) define the domains of the variables just introduced. \hat{M} is used to denote a large enough value, e.g., 100000.

### Battery Management Constraints

Moving nodes may not be connected to an unlimited power source. For this reason, at any optimization round, the distributed multi-period orchestrator must verify that at least one reachable recharging station is in range to support each moving hosting machine. This means that the recharging station selected by the distributed multi-period orchestrator may be different from the charging station that will be selected by the energy manager described in Section 6. The following group of constraints is introduced to guarantee the availability of recharging stations:

$$\begin{matrix}{\sum }_{j ∈ \hat{N}} {Θ}_{ij} = 1 & ∀ i ∈ \overline{N} ,\end{matrix} \qquad ( 56 )$$

$$\begin{matrix}{\hat{v}}_{i}^{X} \geq {λ}_{i}^{X} - {λ}_{j}^{X} - \hat{M} ( 1 - {Θ}_{ij} ) & ∀ i ∈ \overline{N} , j ∈ \hat{N} ,\end{matrix} \qquad ( 57 )$$

$$\begin{matrix}{\hat{v}}_{i}^{X} \geq - {λ}_{i}^{X} + {λ}_{j}^{X} - \hat{M} ( 1 - {Θ}_{ij} ) & ∀ i ∈ \overline{N} , j ∈ \hat{N} ,\end{matrix} \qquad ( 58 )$$

$$\begin{matrix}{\hat{v}}_{i}^{Y} \geq {λ}_{i}^{Y} - {λ}_{j}^{Y} - \hat{M} ( 1 - {Θ}_{ij} ) & ∀ i ∈ \overline{N} , j ∈ \hat{N} ,\end{matrix} \qquad ( 59 )$$

$$\begin{matrix}{\hat{v}}_{i}^{Y} \geq - {λ}_{i}^{Y} + {λ}_{j}^{Y} - \hat{M} ( 1 - {Θ}_{ij} ) & ∀ i ∈ \overline{N} , j ∈ \hat{N} ,\end{matrix} \qquad ( 60 )$$

$$\begin{matrix}{( {\hat{v}}_{i}^{X} )}^{2} + {( {\hat{v}}_{i}^{Y} )}^{2} \leq {( {\overline{Ξ}}_{i}^{rech} {ϑ}_{i} )}^{2} & ∀ i ∈ \overline{N} ,\end{matrix} \qquad ( 61 )$$

$$\begin{matrix}{( {\overline{v}}_{i}^{X} )}^{2} + {( {\overline{v}}_{i}^{Y} )}^{2} \leq {( {\overline{Ξ}}_{i}^{trav} {ϑ}_{i} )}^{2} & ∀ i ∈ \overline{N} ,\end{matrix} \qquad ( 62 )$$

$$\begin{matrix}{\overline{Ξ}}_{j}^{comp} + {\sum }_{i} {\overline{Ξ}}_{i}^{trav} + {\sum }_{i} {\overline{Ξ}}_{i}^{rech} \leq {σ}_{i} + \hat{M} ( 1 - {x}_{ji}^{z} ) & ∀ j ∈ {V}_{z} , z ∈ Z , i ∈ \overline{N} ,\end{matrix} \qquad ( 63 )$$

$$\begin{matrix}{\overline{Ξ}}_{j}^{comm} + {\sum }_{i} {\overline{Ξ}}_{i}^{trav} + {\sum }_{i} {\overline{Ξ}}_{i}^{rech} \leq {σ}_{i} + \hat{M} ( 1 - {\ddot{f}}_{ij}^{z} ) & ∀ j ∈ {V}_{z} , z ∈ Z , i ∈ \overline{N} ,\end{matrix} \qquad ( 64 )$$

$$\begin{matrix}{\sum }_{i} {\overline{Ξ}}_{i}^{trav} + {\sum }_{i} {\overline{Ξ}}_{i}^{rech} \leq {σ}_{i} + \hat{M} ( 1 - {\underline{x}}_{ji} {\sum }_{n ∈ N \backslash \{ i \}} [ {\overline{w}}_{jn}^{z} ] ) & ∀ j ∈ {V}_{z} , z ∈ Z , i ∈ \overline{N} ,\end{matrix} \qquad ( 65 )$$

$$\begin{matrix}{Θ}_{ij} ∈ \{ 0 , 1 \} & ∀ i ∈ \overline{N} , j ∈ \hat{N} ,\end{matrix} \qquad ( 66 )$$

$$\begin{matrix}{\overline{Ξ}}_{i}^{trav} , {\overline{Ξ}}_{i}^{rech} \geq 0 & ∀ i ∈ \overline{N} .\end{matrix} \qquad ( 67 )$$

Equation (56) forces the distributed multi-period orchestrator to assign each moving hosting machine to one hosting machine with battery recharging capabilities. Equations (57)-(60) compute the distance between a hosting machine and its assigned hosting machine with battery recharging capabilities. Equation (61) computes the traveling time necessary to reach the hosting machine with battery recharging capabilities while respecting the maxim speed of the considered moving hosting machine, while Equation (62) computes the minimum traveling time Ξ̅ᵢ^{trav} required by a hosting machine i∈N to move to the desired post-optimization position. Finally, Equation (63) prevents the distributed multi-period orchestrator from assigning a virtualized element (application node) to a hosting machine without enough battery life, while Equation (64) guarantees that enough battery life is available for any moving hosting machines serving traffic demands of an application. Finally, Equation (65) defines battery life constraints for all the moving hosting machines involved in active physical migrations (opportunistic migrations are not considered because the distributed multi-period orchestrator assumes that a hosting machine has enough battery life to complete a preprogrammed travel). Note that \ddot{f}ᵢⱼ^{z} and w̅ᵢⱼ^{z} variables are computed in the next groups of constraints. For sake of completeness, Equations (66)-(67) define the domains of the variables just introduced.

### Reputation and Availability Constraints

The following group of constraints is used to manage the placement aspects related to the fact the hosting machine may appear and depart in an emergent (opportunistic, unscheduled) way:

κ̅ᵢxᵢⱼ^{z}≤κⱼ ∀z∈Z,i∈V_{z}, j∈N, (68)

ψᵢⱼ^{z}≥Ξ̅ⱼ^{comp}+Ξ̅ᵢ^{trav}−Ξᵢ−\hat{M}(1−xᵢⱼ^{z}) ∀z∈Z,j∈V_{z},i∈N, (69)

ψᵢⱼ^{z}≥Ξ̅ⱼ^{comm}+Ξ̅ᵢ^{trav}−Ξᵢ−\hat{M}(1−\ddot{f}ᵢⱼ^{z}) ∀z∈Z,j∈V_{z},i∈N, (70)

ψᵢⱼ^{z}≤\hat{M}ψ̅ⱼ^{z} ∀z∈Z,j∈V_{z},i∈N, (71)

ψⱼᵢ^{z}≥0 ∀z∈Z,i∈V_{z},j∈N. (72)

Equation (68) states that a multi-period placement configuration is valid if and only if a hosting machine j∈N has a reputation κⱼ greater than the minimum reputation level κ̅ᵢ required by a virtualized element (application node) i∈V_{z} of application z∈Z. Equations (69)-(70) evaluate the amount of uncertain operation time for a virtualized element (application node), which depends on the availability of both the hosting machines and the communication nodes in support. Uncertain operation time is considered whenever a virtualized element (application node) is expected to finish after the estimated departure time of the hosting machine or of the many supporting communication nodes. Finally, Equation (71) prevents the distributed multi-period orchestrator from placing premium virtualized elements (application nodes) i∈V_{z} of application z∈Z (ψ̅ᵢ^{z}=1) on the top of hosting machines expected to leave before the end of operations. For sake of completeness, Equation (72) defines the domain of the variables just introduced.

### Migration Constraints

Virtualized elements (application nodes) can be moved from their current hosting machine to another hosting machine because requested by the users (by changing, for instance, the FOA of the application node) or to mitigate resource availability problems. The next group of constraints is defined to manage this process, which can be completed by exploiting network based data transfer, as well as the physical movement of data. Note that set Ni with i E N is used to denote the set of hosting machines defined as N\{i}, while set V_{z}ⁱ with i∈V_{z} and z∈Z is used to denote the set of application nodes defined as V_{z} \{i}

$$\begin{matrix}[ {\sum }_{n ∈ N \backslash \{ j \}} {\underline{x}}_{in}^{z} ] + {x}_{ij}^{z} - 1 \leq {w}_{ij}^{z} + {\overline{w}}_{ij}^{z} + {\hat{w}}_{ij}^{z} & ∀ z ∈ Z , i ∈ {V}_{z} , j ∈ N ,\end{matrix} \qquad ( 73 )$$

$$\begin{matrix}{w}_{ij}^{z} + {\overline{w}}_{ij}^{z} + {\hat{w}}_{ij}^{z} \leq {γ}_{j} & ∀ z ∈ Z , i ∈ {V}_{z} , j ∈ N ,\end{matrix} \qquad ( 74 )$$

$$\begin{matrix}{( {ϑ}_{n} {M}_{i}^{down} )}^{2} + \hat{M} ( 1 - {\overline{w}}_{ij}^{z} ) \geq {\underline{x}}_{in}^{z} ( {( {\overline{v}}_{n}^{X} )}^{2} + {( {\overline{v}}_{n}^{Y} )}^{2} ) & ∀ z ∈ Z , i ∈ {V}_{z} , n ∈ N , j ∈ {N}_{n}\end{matrix} \qquad ( 75 )$$

$$\begin{matrix}{{\underline{x}}_{in}^{z} ( {λ}_{n}^{X} - {\underline{λ}}_{j}^{X} )}^{2} + {{\underline{x}}_{in}^{z} ( {λ}_{n}^{Y} - {\underline{λ}}_{j}^{Y} )}^{2} \leq \hat{M} ( 1 - {\overline{w}}_{ij}^{z} ) & ∀ z ∈ Z , i ∈ {V}_{z} , n ∈ N , j ∈ {N}_{n}\end{matrix} \qquad ( 76 )$$

$$\begin{matrix}{\overline{w}}_{ij}^{z} \leq {\underline{x}}_{in}^{z} {\underline{ϖ}}_{n}^{z} {ϖ}_{n}^{z} & ∀ z ∈ Z , i ∈ {V}_{z} , n ∈ N , j ∈ {N}_{n} ,\end{matrix} \qquad ( 77 )$$

$$\begin{matrix}{\underline{x}}_{im}^{z} {\hat{w}}_{ij}^{z} \leq {n}_{mj} & ∀ z ∈ Z , i ∈ {V}_{z} , m ∈ N , j ∈ {N}_{m} ,\end{matrix} \qquad ( 78 )$$

$$\begin{matrix}{\underline{x}}_{im}^{z} {M}_{i}^{down} {\hat{w}}_{ij}^{z} \leq {d}_{mj} & ∀ z ∈ Z , i ∈ {V}_{z} , m ∈ N , j ∈ {N}_{m} ,\end{matrix} \qquad ( 79 )$$

$$\begin{matrix}{\hat{w}}_{ij}^{z} \leq {\underline{x}}_{in}^{z} {\underline{ϖ}}_{n}^{z} {ϖ}_{n}^{z} & ∀ z ∈ Z , i ∈ {V}_{z} , n ∈ N , j ∈ {N}_{n} ,\end{matrix} \qquad ( 80 )$$

$$\begin{matrix}( {w}_{ij}^{z} + {\overline{w}}_{ij}^{z} ) \leq ( 1 - {\underline{x}}_{hj}^{z} {\overline{w}}_{hl}^{z} ) & ∀ z ∈ Z , i , h ∈ {V}_{z} , j ∈ N , l ∈ {N}_{j} ,\end{matrix} \qquad ( 81 )$$

$$\begin{matrix}{\overline{w}}_{ij}^{z} + {\hat{w}}_{ij}^{z} \leq 2 {\underline{x}}_{in}^{z} {ϖ}_{n}^{z} & ∀ z ∈ Z , i ∈ {V}_{z} , j ∈ N , n ∈ {N}_{j} ,\end{matrix} \qquad ( 82 )$$

$$\begin{matrix}{\underline{Υ}}_{ij}^{z} ( {w}_{in}^{z} - {w}_{jn}^{z} ) = 0 & ∀ z ∈ Z , i ∈ {V}_{z} , j ∈ {V}_{z}^{i} , n ∈ N ,\end{matrix} \qquad ( 83 )$$

$$\begin{matrix}{\underline{Υ}}_{ij}^{z} ( {\overline{w}}_{in}^{z} - {\overline{w}}_{jn}^{z} ) = 0 & ∀ z ∈ Z , i ∈ {V}_{z} , j ∈ {V}_{z}^{i} , n ∈ N ,\end{matrix} \qquad ( 84 )$$

$$\begin{matrix}{\underline{Υ}}_{ij}^{z} ( {\hat{w}}_{in}^{z} - {\hat{w}}_{jn}^{z} ) = 0 & ∀ z ∈ Z , i ∈ {V}_{z} , j ∈ {V}_{z}^{i} , n ∈ N ,\end{matrix} \qquad ( 85 )$$

$$\begin{matrix}{w}_{ij}^{z} , {\overline{w}}_{ij}^{z} , {\hat{w}}_{ij}^{z} ∈ \{ 0 , 1 \} & ∀ z ∈ Z , i ∈ {V}_{z} , j ∈ N .\end{matrix} \qquad ( 86 )$$

Equation (73) is necessary to correctly activate binary migration variables any time a virtualized element (application node) is moved to a new hosting machine, while Equation (74) guarantees that only one type of migration is selected (network-based, physical active, physical opportunistic) and that the migration is not done toward a busy hosting machine. Equation (75) prevents the distributed multi-period orchestrator from commanding an active physical migration if the current hosting machine cannot move fast enough to cover the required distance before the maximum down-time delay is expired. Equation (76) forces the hosting machine supporting an active physical migration to physically move toward the destination hosting machine. It will be appreciated that the destination hosting machine will be free to move, if necessary, after the successful migration; for this reason, the pre-optimization position (not the post-optimization one) of the destination hosting machine is considered in Eq. (76). Equations (77), (80) and (82) forbid the distributed multi-period orchestrator to support physical migrations for the virtualized elements (application nodes) of a given application when the hosting machines are currently running the virtualized elements (application nodes) of other applications (in this way we prevent performance degradation for these other applications). It will be appreciated that these equation could be relaxed to allow a hosting machine to first migrate by network all the virtualized elements (application nodes) of the other applications, and then start the physical migrations. Further information on the control of variables ω̅ are expressed in Equations (111)-(113) presented in the section dealing with network routing in mobile environments.

Equation (78) allows a hosting machine to support an opportunistic physical migration if the hosting machine itself had previously communicated that it will move toward the necessary destination hosting machine, while Equation (79) guarantees that the pre-planned movement will end before the maximum downtime period allowed for the virtualized element (application node) to be migrated expires. Equation (81) prevents a physical migration hosting machine to become the migration target of other virtualized elements (application nodes) of the same application. It will be appreciated that we do not explicitly consider virtualized elements (application nodes) of other applications because they are prevented from migrating toward a physical migration hosting machine by the presence of Equations (77) and (80). Equation (82) prevents physical migration hosting machines from hosting virtualized elements (application nodes) of other applications not involved with the migrating virtualized elements (application nodes).

Finally, Equations (83)-(85) force the distributed multi-period orchestrator to move together the virtualized elements (application nodes) sharing the same resources. For sake of completeness, the domains of migration variables are defined by Equation (86).

### Routing in Wireless Networks

All the constraints and variables required to optimize routing into the virtualization ready physical infrastructure managed by the distributed multi-period orchestrator to support standard traffic demands, migration traffic, and deployment traffic are now introduced:

$$\begin{matrix}{y}_{ijhs}^{z} \geq {x}_{ih}^{z} + {x}_{js}^{z} - 1 & ∀ z ∈ Z , ( i , j ) ∈ {A}_{z} , h ∈ N , s ∈ {N}_{h} ,\end{matrix} \qquad ( 87 )$$

$$\begin{matrix}{y}_{ijhs}^{z} \leq {x}_{ih}^{z} & ∀ z ∈ Z , ( i , j ) ∈ {A}_{z} , h ∈ N , s ∈ {N}_{h} ,\end{matrix} \qquad ( 88 )$$

$$\begin{matrix}{y}_{ijhs}^{z} \leq {x}_{js}^{z} & ∀ z ∈ Z , ( i , j ) ∈ {A}_{z} , h ∈ N , s ∈ {N}_{h} ,\end{matrix} \qquad ( 89 )$$

$$\begin{matrix}{\sum }_{p ∈ P} {π}_{pij} = Λ {{\sum }_{h ∈ N}}_{s ∈ {N}_{h}} {y}_{ijhs}^{z} & ∀ z ∈ Z , ( i , j ) ∈ {A}_{z} ,\end{matrix} \qquad ( 90 )$$

$$\begin{matrix}{π}_{pij} \leq {y}_{{ijo}_{p} {t}_{p}}^{z} & ∀ z ∈ Z , ( i , j ) ∈ {A}_{z} , p ∈ P ,\end{matrix} \qquad ( 91 )$$

$$\begin{matrix}{\sum }_{p ∈ P} {\hat{π}}_{pi} = Λ {\sum }_{j ∈ N} {w}_{ij}^{z} & ∀ z ∈ Z , i ∈ {V}_{z} ,\end{matrix} \qquad ( 92 )$$

$$\begin{matrix}{\hat{π}}_{pi} \leq {\underline{x}}_{{io}_{p}}^{z} {w}_{{it}_{p}}^{z} & ∀ z ∈ Z , i ∈ {V}_{z} , p ∈ P ,\end{matrix} \qquad ( 93 )$$

$$\begin{matrix}{\sum }_{p ∈ P} {\overline{π}}_{pi} \geq Λ {\sum }_{j ∈ N} [ {x}_{ij}^{z} - {\underline{x}}_{ij}^{z} ] & ∀ z ∈ Z , i ∈ {N}_{z} ,\end{matrix} \qquad ( 94 )$$

$$\begin{matrix}{\overline{π}}_{pi} \leq {l}_{{o}_{p} i}^{z} {x}_{{it}_{p}}^{z} & ∀ z ∈ Z , i ∈ {V}_{z} , p ∈ P ,\end{matrix} \qquad ( 95 )$$

$$\begin{matrix}{f}_{ij} \geq {{\sum }_{p ∈ P :}}_{( i , j ) ∈ P} {\sum }_{{( n , m ) ∈ {A}_{z}}_{z ∈ Z}} {δ}_{nm}^{z} {π}_{pnm} ( 1 - {\overline{Υ}}_{nm}^{z} ) & ∀ ( i , j ) ∈ E ,\end{matrix} \qquad ( 96 )$$

$$\begin{matrix}{\overline{f}}_{ij} \geq {{\sum }_{p ∈ P :}}_{( i , j ) ∈ P} {\sum }_{{n ∈ {V}_{z}}_{z ∈ Z}} \{ {l}_{{o}_{p} n}^{z} {\overline{δ}}_{n} {x}_{{nt}_{p}}^{z} ( 1 - {\hat{Υ}}_{n}^{z} ) \} & ∀ ( i , j ) ∈ E ,\end{matrix} \qquad ( 97 )$$

$$\begin{matrix}{\hat{f}}_{ij} \geq {{\sum }_{p ∈ P :}}_{( i , j ) ∈ P} {\sum }_{{n ∈ {V}_{z}}_{z ∈ Z}} \{ {\hat{δ}}_{n} {\hat{π}}_{pn} ( 1 - {\underline{Υ}}_{n}^{z} ) \} & ∀ ( i , j ) ∈ E ,\end{matrix} \qquad ( 98 )$$

$$\begin{matrix}{π}_{pij} \leq {\underline{π}}_{pij} + {γ}_{p} & ∀ z ∈ Z , ( i , j ) ∈ {A}_{z} , p ∈ P ,\end{matrix} \qquad ( 99 )$$

$$\begin{matrix}{\hat{π}}_{pi} \leq {\underline{\hat{π}}}_{pi} + {γ}_{p} & ∀ z ∈ Z , i ∈ {V}_{z} , p ∈ P ,\end{matrix} \qquad ( 100 )$$

$$\begin{matrix}{\overline{π}}_{pi} \leq {\overline{\underline{π}}}_{pi} + {γ}_{p} & ∀ z ∈ Z , i ∈ {V}_{z} , p ∈ P ,\end{matrix} \qquad ( 101 )$$

$$\begin{matrix}{π}_{pij} ∈ \{ 0 , 1 \} & ∀ z ∈ Z , ( i , j ) ∈ {A}_{z} , p ∈ P ,\end{matrix} \qquad ( 102 )$$

$$\begin{matrix}{\hat{π}}_{pi} , {\overline{π}}_{pi} ∈ \{ 0 , 1 \} & ∀ z ∈ Z , i ∈ {V}_{z} , p ∈ P ,\end{matrix} \qquad ( 103 )$$

$$\begin{matrix}{y}_{ijhs}^{z} ∈ \{ 0 , 1 \} & ∀ z ∈ Z , ( i , j ) ∈ {A}_{z} , h ∈ N , s ∈ {N}_{h} ,\end{matrix} \qquad ( 104 )$$

$$\begin{matrix}{f}_{ij}^{z} , {\hat{f}}_{ij}^{z} , {\overline{f}}_{ij}^{z} \geq 0 & ∀ z ∈ Z , ( i , j ) ∈ E .\end{matrix} \qquad ( 105 )$$

Equations (87)-(89) are necessary to correctly compute traffic demand placement variables y. Equation (90) states that at least A (reliability level) paths are activated to serve each traffic demand (i,j)∈A_{z} of application z∈Z, while Equation (91) prevents the distributed multi-period orchestrator from activating the wrong paths (those not connecting the source and the destination of the corresponding traffic demand once it has been placed). Equation (92) has the same responsibility of Equation (90), but in this case tha routing paths are selected to support virtualized element (application node) migrations. Similarly to (91), Equation (93) guarantees that the activated paths are able to support the pair of hosting machines involved in the corresponding migration. Again, Equations (94)-(95) are used to activate at least Λ routing paths to support the first deployment of a virtualized element (application node), while choosing the correct paths in terms of source and destination hosting machines. Equations (96)-(98) are used to compute the total amount of flow produced on each link by each type of traffic, i.e., standard, migration-based, deployment-based. Note that Υ variables are used to discard the portion of traffic that can be shared by co-placed virtualized elements (application nodes). Finally, Equations (99)-(101) prevents the distributed multi-period orchestrator from modifying the routing variables involving busy links (e.g., links of hosting machines that are moving). For sake of completeness, variable domains are defined by Equations (102)-(105).

### Routing in Mobile Environments

In fully mobile environment, network performances can be guaranteed only if node movement is somehow controlled. The moving nodes are dedicated to serve only a specific application z∈Z. In this way, the movements caused by the virtualized elements (application nodes) of an application should not interfere with the performance of other applications running on an overlapping subset of hosting machines. The following group of constraints are defined:

$$\begin{matrix}{f}_{ij}^{z} \geq {{\sum }_{p ∈ P :}}_{( i , j ) ∈ P} {\sum }_{( n , m ) ∈ {A}_{z}} {δ}_{nm}^{z} {π}_{pnm} & ∀ z ∈ Z , ( i , j ) ∈ E ,\end{matrix} \qquad ( 106 )$$

$$\begin{matrix}{\hat{f}}_{ij}^{z} \geq {{\sum }_{p ∈ P :}}_{( i , j ) ∈ P} {\sum }_{n ∈ {V}_{z}} {\hat{δ}}_{n} {\hat{π}}_{pn} & ∀ z ∈ Z , ( i , j ) ∈ E ,\end{matrix} \qquad ( 107 )$$

$$\begin{matrix}{\overline{f}}_{ij}^{z} \geq {{\sum }_{p ∈ P :}}_{( i , j ) ∈ P} {\sum }_{n ∈ {V}_{z}} {l}_{{o}_{p} n}^{z} {\overline{δ}}_{n} {x}_{{nt}_{p}}^{z} & ∀ z ∈ Z , ( i , j ) ∈ E ,\end{matrix} \qquad ( 108 )$$

$$\begin{matrix}\hat{M} {\dot{f}}_{ij}^{z} \geq {f}_{ij}^{z} + {\hat{f}}_{ij}^{z} + {\overline{f}}_{ij}^{z} & ∀ z ∈ Z , ( i , j ) ∈ E ,\end{matrix} \qquad ( 109 )$$

$$\begin{matrix}\hat{M} {\ddot{f}}_{ij}^{z} \geq {{{{\sum }_{p ∈ P :}}_{( i , h ) ∈}}_{∨}}_{( h , i ) ∈ P} {{\sum }_{m ∈ {V}_{z} :}}_{( j , m ) ∈ {A}_{z}} {δ}_{jm}^{z} {π}_{pjm} ++ {{{{\sum }_{p ∈ P :}}_{( i , h ) ∈ P}}_{∨}}_{( h , i ) ∈ P} {{\sum }_{m ∈ {V}_{z} :}}_{( m , j ) ∈ {A}_{z}} {δ}_{mj}^{z} {π}_{pmj} & ∀ z ∈ Z , j ∈ {V}_{z} , i ∈ N ,\end{matrix} \qquad ( 110 )$$

$$\begin{matrix}{ϖ}_{i}^{z} \leq ( 1 - {x}_{ji}^{h} ) & ∀ z ∈ Z , h ∈ Z \backslash \{ z \} , i ∈ N , j ∈ {V}_{h} ,\end{matrix} \qquad ( 111 )$$

$$\begin{matrix}{ϖ}_{i}^{z} \leq ( 1 - {\dot{f}}_{ij}^{h} ) & ∀ z ∈ Z , h ∈ Z \backslash \{ z \} , ( i , j ) ∈ E ,\end{matrix} \qquad ( 112 )$$

$$\begin{matrix}{ϖ}_{i}^{z} \leq ( 1 - {\dot{f}}_{ji}^{h} ) & ∀ z ∈ Z , h ∈ Z \backslash \{ z \} , ( j , i ) ∈ E ,\end{matrix} \qquad ( 113 )$$

$$\begin{matrix}{\overline{v}}_{i}^{X} + {\overline{v}}_{i}^{Y} \leq \hat{M} {ϖ}_{i}^{z} & ∀ i ∈ N ,\end{matrix} \qquad ( 114 )$$

$$\begin{matrix}0 \leq {f}_{ij}^{z} , {\hat{f}}_{ij}^{z} , {\overline{f}}_{ij}^{z} , {τ}_{ij} & ∀ z ∈ Z , ( i , j ) ∈ E ,\end{matrix} \qquad ( 115 )$$

$$\begin{matrix}{\dot{f}}_{ij}^{z} ∈ \{ 0 , 1 \} & ∀ z ∈ Z , ( i , j ) ∈ E ,\end{matrix} \qquad ( 116 )$$

$$\begin{matrix}{\ddot{f}}_{ij}^{z} ∈ \{ 0 , 1 \} & ∀ z ∈ Z , j ∈ {V}_{z} , i ∈ N ,\end{matrix} \qquad ( 117 )$$

$$\begin{matrix}{ϖ}_{i}^{z} ∈ \{ 0 , 1 \} & ∀ z ∈ Z , i ∈ N .\end{matrix} \qquad ( 118 )$$

First, Equations (106)-(108) are used to compute the total amount of traffic carried by a link which is generated by a specific application (the three types of traffic). Note that for our purpose we do not have to consider sharing variables Υ like in Equations (96)-(98). Then, Equation (109) is used to determine whether a link is used by the traffic related to a specific application z∈Z, while Equation (110) has the same responsibility related to the fact that a hosting machine is serving traffic generated by a specific virtualized element (application node). Equations (111)-(113) allow to mark a hosting machine as communication node for a given application z∈Z if and only if it is not involved in any way with other applications (neither hosting their virtualized elements, nor serving their network traffic). Finally, according to Equation (114), only communication hosting machines assigned to a given application can move. For sake of completeness, variable domains are defined by Equations (115)-(118).

### Mobile Link Capacities

In wireless networks, there exists a potential physical network link for each pair of hosting machines with a wireless network interface. The network bandwidth offered by each wireless link is related to the distance between the hosting machines at the extremities of the considered links. Note that in case of wired links, the link throughput/capacity is instead fixed (one single horizontal piece). The following group of constraints allows to correctly compute the current link capacities and, consequently, to respect them:

$$\begin{matrix}{( {v}_{ij}^{X} )}^{2} + {( {v}_{ij}^{Y} )}^{2} \leq {( {l}_{h}^{+} )}^{2} + \hat{M} ( 1 - {\dot{c}}_{ijh} ) & ∀ ( i , j ) ∈ E , h ∈ {H}^{ij} ,\end{matrix} \qquad ( 119 )$$

$$\begin{matrix}{\sum }_{h ∈ {H}^{ij}} {\dot{c}}_{ijh} = 1 & ∀ ( i , j ) ∈ E ,\end{matrix} \qquad ( 120 )$$

$$\begin{matrix}{f}_{ij} + {\hat{f}}_{ij} + {\overline{f}}_{ij} \leq C {\sum }_{h ∈ {H}^{ij}} [ {\dot{\underline{c}}}_{ijh} {c}_{ijh} ] & ∀ ( i , j ) ∈ E ,\end{matrix} \qquad ( 121 )$$

$$\begin{matrix}{f}_{ij} \leq C {\sum }_{h ∈ {H}^{ij}} [ {\dot{c}}_{ijh} {c}_{ijh} ] & ∀ ( i , j ) ∈ E ,\end{matrix} \qquad ( 122 )$$

$$\begin{matrix}{\overline{τ}}_{ij} \geq D ( \frac{{f}_{ij} + {\hat{f}}_{ij} + {\overline{f}}_{ij}^{z}}{{\sum }_{h ∈ {H}^{ij}} [ {\dot{\underline{c}}}_{ijh} {c}_{ijh} ]} ) & ∀ ( i , j ) ∈ E ,\end{matrix} \qquad ( 123 )$$

$$\begin{matrix}{τ}_{ij} \geq D ( \frac{{f}_{ij}}{{\sum }_{h ∈ {H}^{ij}} [ {\dot{c}}_{ijh} {c}_{ijh} ]} ) & ∀ ( i , j ) ∈ E ,\end{matrix} \qquad ( 124 )$$

$$\begin{matrix}{\overline{τ}}_{p} \geq {\sum }_{( i , j ) ∈ P} {\overline{τ}}_{ij} & ∀ p ∈ P ,\end{matrix} \qquad ( 125 )$$

$$\begin{matrix}{τ}_{p} \geq {\sum }_{( i , j ) ∈ P} {τ}_{ij} & ∀ p ∈ P ,\end{matrix} \qquad ( 126 )$$

$$\begin{matrix}{\overline{τ}}_{p} \leq {Δ}_{ij}^{z} + \hat{M} ( 1 - {y}_{{ijo}_{p} {t}_{p}}^{z} ) & ∀ z ∈ Z , ( i , j ) ∈ {A}_{z} , p ∈ P ,\end{matrix} \qquad ( 127 )$$

$$\begin{matrix}{τ}_{p} \leq {Δ}_{ij}^{z} + \hat{M} ( 1 - {y}_{{ijo}_{p} {t}_{p}}^{z} ) & ∀ z ∈ Z , ( i , j ) ∈ {A}_{z} , p ∈ P ,\end{matrix} \qquad ( 128 )$$

$$\begin{matrix}{\dot{c}}_{ijh} ∈ \{ 0 , 1 \} & ∀ , ( i , j ) ∈ E , h ∈ {H}^{ij} ,\end{matrix} \qquad ( 129 )$$

$$\begin{matrix}{τ}_{ij} , {\overline{τ}}_{ij} \geq 0 & ∀ ( i , j ) ∈ E ,\end{matrix} \qquad ( 130 )$$

$$\begin{matrix}{τ}_{p} , {\overline{τ}}_{p} \geq 0 & ∀ p ∈ P ,\end{matrix} \qquad ( 131 )$$

$$\text{?} \qquad ( 132 )$$

$$\text{?} \text{indicates text missing or illegible when filed}$$

Equation (119) is used to correctly activate the right piece of the throughput distance function of each physical link, while Equation (120) imposes that one piece of that function is activated per link. Equations (121) and (122) prevent the capacity of each link from being overutilized (with both pre-optimization and post-optimization node positions). Equations (123)-(124) compute the link delay with pre-optimization and post-optimization node positions, while Equations (125)-(126) do the same but for path delays. Finally, Equations (127) and (128) enforce maximum path delay constraints, by considering both pre-optimization and postoptimization positions. For sake of completeness, variable domains are defined by Equations (129)-(131).

### Mobile Cell Capacities

Wireless nodes communicating over the same Wireless Local Area Network (WLAN) are typically required to configure all the D2D wireless link on the same transmission channel. This leads all the links of the same WLAN that are in range with respect to each other to share the same spectrum, and thus the same transmission capacity. The following group of constraints is introduced to model this phenomenon:

$$\begin{matrix}{( {v}_{ij}^{X} )}^{2} + {( {v}_{ij}^{Y} )}^{2} \geq {( {l}_{h}^{-} )}^{2} ( 1 - {e}_{ij} ) & ∀ ( i , j ) ∈ E , h ∈ last ( {H}^{ij} ) ,\end{matrix} \qquad ( 133 )$$

$$\begin{matrix}{e}_{ijn} \geq {e}_{in} & ∀ ( i , j ) ∈ E , n ∈ N \backslash \{ i , j \} ,\end{matrix} \qquad ( 134 )$$

$$\begin{matrix}{e}_{ijn} \geq {e}_{jn} & ∀ ( i , j ) ∈ E , n ∈ N \backslash \{ i , j \} ,\end{matrix} \qquad ( 135 )$$

$$\begin{matrix}{\sum }_{( n , m ) ∈ {\underline{E}}_{i}} [ {f}_{nm} + {\hat{f}}_{nm} + {\overline{f}}_{nm} ] \leq {\overline{\underline{c}}}_{i} & ∀ i ∈ N ,\end{matrix} \qquad ( 136 )$$

$$\begin{matrix}{\sum }_{( n , m ) ∈ E} {e}_{nmi} {f}_{nm} \leq {\overline{c}}_{i} & ∀ i ∈ N ,\end{matrix} \qquad ( 137 )$$

$$\begin{matrix}D ( \frac{{\sum }_{( n , m ) ∈ {\underline{E}}_{i}} [ {f}_{nm} + {\hat{f}}_{nm} + {\overline{f}}_{nm} ]}{{\overline{\underline{c}}}_{i}} ) \leq {\overline{τ}}_{i} & ∀ i ∈ N ,\end{matrix} \qquad ( 138 )$$

$$\begin{matrix}D ( \frac{{\sum }_{( n , m ) ∈ E} {e}_{nmi} [ {f}_{nm} ]}{{\overline{c}}_{i}} ) \leq {τ}_{i} & ∀ i ∈ N ,\end{matrix} \qquad ( 139 )$$

$$\begin{matrix}{e}_{in} ∈ \{ 0 , 1 \} & ∀ , i ∈ N , n ∈ N \backslash \{ i \} ,\end{matrix} \qquad ( 140 )$$

$$\begin{matrix}{e}_{ijn} ∈ \{ 0 , 1 \} & ∀ , ( i , j ) ∈ E , n ∈ N \backslash \{ i , j \} ,\end{matrix} \qquad ( 141 )$$

$$\begin{matrix}{τ}_{i} , {\overline{τ}}_{i} \geq 0 & ∀ i ∈ N .\end{matrix} \qquad ( 142 )$$

Equation (133) is necessary to evaluate when a hosting machine is close enough to another hosting machine to be considered as a member of the wireless cell of this latter. Equations (134)-(135) are used to determine the physical links that are members of a given wireless cell: it is sufficient the one of the two edges of the considered link is member of the wireless cell itself. Equations (136) and (137) prevent the capacity of each wireless cell from being over-utilized (with both pre-optimization and post-optimization node positions). Finally, Equations (138)-(139) compute the wireless cell utilization costs by considering both pre-optimization and post-optimization node positions. For sake of completeness, variable domains are defined by Equations (140)-(141).

### 4.2 the Algorithm for Distributed Multi-Period Workload Placement

The MINP formulation just presented in Section 4.1 to define the multi-period workload placement problem is crucial to:
Determine which combinations of placement decisions are feasible.
Compare the quality of different feasible solutions with respect to the defined multi-objective function.

The role of the distributed multi-period orchestrator is to heuristically compute, in real-time, a feasible and optimal placement solution.

A small part of the information necessary to solve the multi-period workload placement problem is found directly in configuration files visible to the distributed multi-period orchestrator instance (see Section 4.3) running on each hosting machine. The remaining information is instead collected by the distributed multi-period orchestrator instance of each hosting machine from the other auxiliary modules (see Section 4.4).

The implementation details of the distributed multi-placement workload placement algorithm run by the distributed multi-period orchestrator instance of each hosting machine (when necessary) are now introduced. A founding principle of the algorithm is that the optimization process should not consider, at each optimization iteration, the whole virtualization ready physical infrastructure. Such a global approach would create issues in terms of:
Overhead generated by the necessity of transmitting all the problem information to at least one centralized orchestration instance.
High computing times caused by the combinatorial explosion of variables and constraints to be considered.
Management of mobile opportunistic nodes.

To mitigate such problems, multiple sub-clusters i∈Q made by hosting machines and links laying in close proximity (in terms of hop-distance) are dynamically built. In this way, each sub-cluster i∈Q can solve a small-size instance of the multi-period workload placement problem involving just the hosting machines belonging to the corresponding sub-cluster, i.e.:
Subset \ddot{N}ᵢ of hosting machines of sub-cluster i∈Q.
Subset Ëᵢ of physical network links of sub-cluster i∈Q.
Subset \ddot{P}ᵢ of routing paths interconnecting the hosting machines \ddot{N}ᵢ by exploiting only links of Ëᵢ.

And all related parameters. The flow process describing the optimal orchestration mechanism is now presented:

### 1. Optimization Triggering Event

A triggering event requiring placement optimization is registered by the distributed multi-period orchestration instance of a hosting machine belonging to N:
Periodical re-optimization request: the distributed multi-period orchestrator of the hosting machine elected as sub-cluster supervisor (see next part on cluster formation) periodically generates a re-optimization request. The rationale behind this mechanism is that a periodical re-organization can exploit real-time resource requirement values depending on the real resource consumption values observed for the virtualized elements (application nodes) already placed. These values could greatly deviate with respect to the nominal values configured for the first placement operation by the multi-period workload generation module. Note that multiple sub-cluster supervisor nodes can be elected to improve the sub-cluster resilience.
De-allocation event: a virtualized element is removed and the corresponding sub-cluster supervisor node generates a re-organization request to improve performance or place virtualized elements (application nodes) that could not be placed before.
New application event: a new application placement request is received by the orchestration instance of a hosting machine (typically a gateway node for requests coming from the Internet) from a multi-period workload generation module.
Application modification request: a modification request for an application already placed is received by a hosting machine. The request is redirected to the distributed multi-period orchestrator instance of the sub-cluster supervisor hosting machine managing the sub-cluster where the application is currently running. The application modification may directly produce a migration if the DOA is changed.
Performance degradation alert: the virtualization engine of a hosting machine observes a degradation performance of a virtualized element (application node), so it transmits a re-organization request to the distributed multi-period orchestrator instance of the sub-cluster supervisor physical machine responsible for the virtualized element itself.
New hosting machine event: all the distributed multi-period orchestrator instances of the sub-cluster supervisor hosting machines laying within a certain hop-distance (on the telecommunication network) from a new hosting machine are notified of the potential availability of new resources. A new placement re-organization request may be generated on these hosting machines.
Hosting machine or physical link departure/failure/temporary unavailability: the distributed multi-period orchestrators of the supervisor hosting machines of the sub-cluster interested by a node/link departure/failure/temporary unavailability generate a new placement re-organization request. It will be appreciated that temporary unavailability can be related to battery recharging operations triggered by the energy manager (see Section 6)
etc.

### 2. Cluster Formation

The generation of a multi-period placement optimization or multi-period placement re-organization request triggers the dynamic formation of new sub-clusters. First of all, the behavior of the hosting machine whose distributed multi-period orchestrator instance generated the optimization request is now analyzed:
If the hosting machine does not have any sub-cluster supervising responsibilities, it will trigger the progressive construction of one or more new sub-clusters that it will lead as supervisor in case the placement bidding process is won (see Paragraph 4 below).
If the hosting machine is already a supervisor for one or more sub-clusters, it will trigger the placement optimization algorithms within these sub-clusters themselves. If configured accordingly, it may also trigger the construction of new sub-clusters through the process described in the previous bullet point.
Independently of its supervisor status, the distributed multi-period orchestrator instance of the hosting machine will broadcast the placement request through DASS (see Section 5), by considering two strategies:
   1. Broadcast limited to a pre-configured hop distance from the hosting machine. Note that the hop distance can be increased and the operation repeated in case no satisfying multi-period placement solution is obtained within the generated sub-clusters.
   2. Broadcast destined to a specific FOA.

All the hosting machines already supervising a sub-cluster that receive a request will automatically try to solve the multi-period workload placement problem within the same sub-cluster. Otherwise, each hosting machine has a certain probability of launching the formation of a new sub-cluster that it will supervise. Note that each supervisor candidate can build multiple clusters of different size in terms of hop-distance from the supervisor hosting machine. The cluster formation managed by a supervisor hosting machine is performed through a consensus algorithm supported by DASS to distribute the necessary information.

Before being ready to compute the best multi-period workload placement solution, the clusters must be further extended to account for:
Placement of new applications: each sub-cluster not including the hosting machine that originated the first optimization request will run a route discovery protocol (similar to those used for ad-hoc network routing) to determine an additional subset of hosting machines and physical links to be included in the cluster to account for deployment bandwidth.
Internet connectivity requirements: a similar process is run to discover Internet gateway nodes in case the involved applications require internet connectivity. Note that a sub-cluster may already include an Internet gateway due to previous placement operations.
Migration for FOA modifications or performance deterioration: in this case, besides discovering and including the nodes and links on the paths between the new sub-cluster and the source sub-cluster (from where operating the migration), the system creates a new super-cluster merging destination and origin sub-clusters.

It will be appreciated that sub-cluster supervisors may be controlled by a specific algorithms aiming to merge overlapping sub-clusters. Furthermore, other algorithms may be constantly run to delete sub-clusters that become idle, as well as split two portions of the same sub-cluster that do not interact among themselves.

### 3. Placement Solution Computation and Intra-Sub-Cluster Bidding

The supervisor hosting machine of a sub-cluster distributes all the new application information to the distributed multi-period orchestrators instances of all the sub-cluster members (through DASS, see Section 5). If the sub-cluster is new, all the hosting machine distributed multi-period orchestrator instances in the sub-cluster will distribute, always with DASS, all the other problem parameters. Otherwise, these information should be already available on each hosting machine.

Once each sub-cluster distributed multi-period orchestrator instance retrieve all the necessary problem parameters, it repeats a certain number of iterations of one or more resolution algorithms. At the end of the process, or after a user-configured time-out, the solution with the best objective function is the only kept. It will be appreciated that any algorithm generating feasible solutions for the MINP formulation of Section 4.1 can be leveraged, including meta-heuristics, local searches, greedy algorithms, genetic algorithms and many others. In this case we propose to use two different greedy algorithms, Feasible Placement (FP) and Optimal Placement (OP), each applied in two different modes, i.e., partial (only the variables related to the application nodes directly involved in the placement optimization—e.g., those of a new application)—can be adjusted) and full (the whole sub-cluster variables can be optimized).

Partial FP and OP should be tried first to avoid migrations and configuration adjustments that may negatively affect the performance of the application nodes already running. In case the solutions of partial methods are not considered good enough, full FP and OP are launched to look for better solutions.

Both FP and OP are based on the same macro-routines:
RSAN: Randomized sorting of the list of virtualized elements (application nodes) to be placed or moved.
RSPN: Randomized sorting of the hosting machines.
RSTD: Randomized sorting of the traffic demands involving the considered virtualized elements (application nodes) and all the other application components already placed, e.g., gateway hosting machines, migration sources, other virtualized elements (application nodes).
FTPV: Feasibility test of a virtualized element (application node) placement option by evaluating resource allocation, geo-location and energy-management constraints—virtualized element (application node) i∈V_{z} of application z∈Z on hosting machine j E N. Note that concerning post-optimization positions (for moving nodes), the feasibility test considers the closest position belonging to the corresponding DOA with respect to the current position of the considered hosting machine.
FTFV: Feasibility test of a traffic demand, a migration demand or a deployment demand placement option.
FE: Evaluation of the objective function value related to current placement configuration.
SPU: Computation of the shortest routing path between a pair of physical machines by considering current link utilization cost values τᵢⱼ.
SPC: Computation of the capacity constrained shortest routing path between a pair of physical machines by considering current link utilization cost values τᵢⱼ.
LID: Identification of LID list containing all the links preventing the computation of a shortest path with enough capacity to host a new traffic demand involved in the new placement decision.
CND: Identification of the nodes in conditions to become communication nodes for a given application.
SPR: Re-positioning of communication nodes to repair a shortest path link without enough capacity to host a traffic demand involved in the new placement decision. If F communication nodes are considered, SPR will just position them along the straight line connecting the two edges of the link to be repaired by obtaining F+1 sub-pieces (sub-links) of equal distance. The reparation fails if the new positions of the communication node causes some network requirement to fail.
FFE: Verification that no placement constraint (some constraints may be impossible to be checked during the greedy placement process) is violated. If violations are identified corresponding application nodes, and even whole applications may be removed.

The macro-routine above is combined to describe the FP algorithm:
1. Initialization: RSAN plus RSPN.
2. Pop the first virtualized element (application node) of the RSAN list.
3. Pop the first hosting machine of the RSPN list.
4. Perform FTPV of the considered virtualized element (application node) on the considered hosting machine. If the placement option is unfeasible, and RSPN list is not empty, then go to Point 3. If the placement option is unfeasible, and RSPN list is empty, then mark the virtualized element (application node) as queued and go to Point 2. Otherwise, go to next Point.
5. Run RSTD to obtain a randomized list of all the network flow requirements related to the considered virtualized element (application node) once placed on the considered hosting machine.
6. Pull the first flow request (traffic demand, or migration traffic request, or deployment traffic request) of the RSTD list.
7. Perform FTFV of the considered flow request, i.e.:
   (a) Compute the SPC between the source and the destination hosting machine (and vice versa). If A valid paths exist and RSTD list is not empty, go to Point 6. If a valid path exists and RSTD list is empty and RSAN list is not empty, mark the virtualized element (application node) as placed and go to Point 2. If Λ valid paths exist and RSTD list is empty and RSAN list is empty, mark the virtualized element (application node) as placed and go to Point 9.
   (b) Compute the SPU between the source and the destination hosting machines (and vice versa).
   (c) Run LID.
   (d) Pop the first link of the LID list.
   (e) Run CND.
   (f) Pop the first node of the CND list.
   (g) Run SPR with all the links popped up to now. If SPR fails and CND is not empty, go to Point 7d. If SPR fails, CND is empty and RSPN list is not empty, then go to Point 3. If SPR fails, CND is empty and RSPN list is empty, then mark the virtualized element (application node) as queued and go to Point 2. If SPR succeeds, mark the flow request as placed and go to Point 6. If SPR succeeds and RSTD list is not empty, mark the flow request as placed and go to Point 6. If SPR succeeds, the RSTD list is empty and RSAN list is not empty, mark the flow request as placed, mark the virtualized element (application node) as placed and go to Point 2. If SPR succeeds, the RSTD list is empty and RSAN list is empty, mark the flow request as placed, mark the virtualized element (application node) as placed and go to Point 9.
8. Run FFE.
9. Run FE and return the corresponding value computed through Eq. 1.

If the BF algorithm is considered, the only difference with respect to the FP procedure just described is the fact that all the hosting machines of the RSPN list are tested with FE (instead of passing to the next step any time a feasible solution is identified) to allow the algorithm to choose the best local decision. It will be appreciated that the greedy approaches of both FP and OP can lead to local optima with a significant gap from the real optimum solution. It will be appreciated that an additional step can be added between FTPV and FTFV to test different the migration types. In a FP approach, the first feasible migration type is maintained, while in a BF approach, all the three migration types could be evaluated (network-based, physical active, physical opportunistic).

DASS is then used by each sub-cluster distributed multi-period orchestrator instance (one per hosting machine) to share the best objective function found. The sub-cluster supervisor will then select the best value and retrieve the corresponding placement solution from the multi-period orchestrator instance that obtained it.

It is worth pointing out that the resolution scheme just presented can be naturally applied to any version of the multi-period workload optimization problem. It could also be easily adapted also to deal with other mathematical formulations for the same problem.

### 4. Inter-Sub-Cluster Bidding

All the sub-cluster supervisor hosting machines will transmit the pair composed by the best objective function and the corresponding multi-period workload placement solution to the distributed multi-period orchestrator instance that originally generated the optimization/re-organization request. This distributed multi-period orchestrator instance is thus responsible of comparing all the solutions received within a pre-configured time limit by multiple sub-cluster supervisors and electing the sub-cluster that won the multi-period workload placement bidding process. The ID and address of the supervisor of the winning sub-cluster is also communicated to the multi-period workload generation module used to create, manage and stop the applications.

### 4.3 Parameters Configured by the Distributed Multi-Period Orchestrator

When the distributed multi-period orchestrator instance is initialized on a hosting machine, a configuration file created by the virtualization ready physical infrastructure manager is read to correctly set some input parameters directly related to the distributed orchestration process:
The set of valid physical resource and capacities R.
The set of valid resource configurations K^{r}.
Resource over provisioning parameters Ωᵣ.
Network link over provisioning parameters C.
Resource utilization cost functions Φᵣ( ).
Link delay/cost function D( ).
The set of objective function weights αᵢ, ∀i∈{1, 2, 3, 4, 5, 6, 7, 8}
Computation time-limit within a sub-cluster.
Overall computation time-limit considered by the distributed multi-period orchestrator instance that generates an optimization request before selecting a winning sub-cluster.
Maximum broadcast hop-limit for sub-cluster research.
   4.4 Interaction with the Other Modules

The distributed multi-period orchestrator instance running on each hosting machine exploits the data distribution/replication services of the DASS to coordinate the distributed solution computation process. A large portion of these interactions has been already documented in Section 4.2. However, it was not mentioned that DASS is crucial to force all the distributed multi-period orchestrator instances to converge to the same set of orchestration parameters (see Section 4.3). This specific convergence task can be executed in collaboration with the access manager described in Section 10.

The distributed multi-period orchestrator instance retrieves all the parameters related to the hosting machines and links of the same sub-clusters by interrogating the other modules running on the same physical machine:
The energy manager: energy consumption, speed and battery autonomy duration parameters.
The geo-location daemon: all physical geo-location parameters.
The reputation estimator: reputation parameters.
The access manager: estimated availability parameters.
The virtualization engine: real time and nominal resource consumption values, network consumption values, state of the application nodes (running, idle, stopped, etc.).
The telecommunication application: routing paths information, link and cell related parameters.

It will be appreciated that each of the modules above retrieves the information from the surrounding hosting machines through the DASS instance running on each hosting machine.

The telecommunication application and the virtualization engine receives all the resource and bandwidth reservation instructions related to the implementation of a new multi-period workload placement configuration. Finally, the distributed multi-period orchestrator instance transmits to the geo-location module all the FOA information of virtualized elements (application nodes) demanding placement; in this way the geolocation module will be able to return the list of hosting machines of the sub-cluster of interests that are compatible with the FOA.

### 5 Distributed Databases for Seamless Information Sharing

A special virtual component is represented by a Distributed Database (DD) middleware specifically tailored to run on the top of Mobile Ad-Hoc Networks (MANETs) and Opportunistic Networks (ONs), and compatible with any kind of network. A DD middleware called Distributed Advanced Storage Service (DASS) was developed. It:
Encapsulates a standard NO-SQL database instance running on the underlying hosting machine.
Adopts policy-driven replication strategies to distribute information among the hosting machines participating to the same DASS instance.
Maintains content-location mapping information to retrieve information not physically placed on the underlying hosting machines.
Run versioning mechanisms.
Run conflict resolutions mechanisms based on user-defined policies.

A DASS instance is run in a dedicated virtual container that is pre-deployed on each hosting machine aiming to participate to the virtualization ready physical infrastructure. The DASS instance is leveraged by the distributed multi-period orchestrator instance of each hosting machine to distribute all the information required by the distributed multi-period workload placement algorithms to build the local sub-clusters and compute the corresponding multi-period workload placement configurations for an application demanding for resources. As already pointed out in the previous section, DASS is exploited by all the other modules (not only the orchestrator) to distribute information across the hosting machines of the virtualization ready physical infrastructure.

### 6 the Energy Manager

The energy manager has the main responsibility of triggering battery recharging procedures (no run by the distributed multi-period orchestration system) that temporary exclude a hosting machine from the virtualization ready physical infrastructure (it is marked as busy through the corresponding γ parameter) to give it time to fulfill recharging procedures. Note that the Θ variables modified by the distributed multi-period orchestrator to assign each moving node to a recharging station are simply used to guarantee that a close enough recharging station is always available; however, these variables have no impact with the energy management routines of the energy management layer.

This module is used to configure:
ϵᵢ: idle energy consumption of the underlying hosting machine.
θᵢ: the maximum moving speed of the underlying hosting machine.
σᵢ: current battery life of the underlying hosting machine.
Σᵢ: current battery life equivalence parameter of the underlying hosting machine.

These parameters are transmitted to the orchestrators of the same hosting machine, as well as they are distributed to the surrounding hosting machines through DASS.

At run-time (at each optimization round) the energy management daemon communicates to the distributed multi-period orchestrator instance of its hosting machine all the real-time battery autonomy data σ.

### 7 the Network Aware Path Manager

The multi-period workload placement solution computed by the distributed multi-period orchestration system determines the final position assigned to a moving hosting machines to satisfy a virtualized element (application node). The solution guarantees that all network related constraints are satisfied by considering both pre-optimization and post-optimization positions of the hosting machines.

The network aware path manager is an auxiliary module that has the responsibility of coordinating the movements of all the moving hosting machines. Its goal is to guarantee that the final network configuration computed by the distributed multi-period orchestration system by considering the hosting machines placed in their destination positions will remain valid along the whole traveling period. It will be appreciated that this process can be decomposed in multiple independent sub-instances (one per application interested by moving tasks) thanks to the problem constraints (111)-(113) that prevent the distributed multi-period orchestrator from co-placing a moving virtualized element with another virtualized element of a different application.

The path planning algorithm can be implemented in many different ways. It can be a centralized path planning algorithm running on each sub-cluster supervisor hosting machine, as well as a distributed network maintenance system based on proper node attraction parameters aiming to keep close the physical edges of the relevant links (see the potential-based method used in [2]).

It will be appreciated that the path-planner is also responsible of physically moving the underlying hosting machine.

### 8 the Geo-Location Daemon

A system based on a software module and a physical interface, or by the combination of more of them, capable of estimating the current position of a host machine.

Examples of geo-location modules include:
GPS based system: a host machine equipped with a GPS interface can estimate its position by trilateration with respect to geostationary satellites.
Ultra-Wide Band (UWB) system: three hosting machines equipped with a UWB interface (e.g., DWM1001 from DecaWave) can compute the relative position of a fourth hosting machine always equipped with a UWB interface by trilateration. The distance between each pair of UWB-powered hosting machines is computed by estimating the flight time of each transmitted communication probe. If one hosting machine is chosen as origin of a reference system of coordinates, all the relative positioning measures done by each subset of four hosting machines can be converted according to it. It will be appreciated that such geo-location module is collaborative and requires all the hosting machines to be on the same telecommunication network.
Wi-Fi range-based system: similar to UWB system. In this case, hosting machines are equipped with a Wi-Fi interface capable of returning the Received Signal Strength Indicator (RSSI) from other hosting machines in range. The relative positions are computed by converting the RSSI into estimated distance values (e.g., by fitting a path loss function). Trilateration processes are thus based on these distance values.

This module also computes, following requests of the distributed multi-period orchestrator, the binary geo-localization parameters Ā_{zij}^{FO} that determine the hosting machines that, based on their location, are authorized to host a given application.

### 9 the Reputation Estimator

Each hosting machine that becomes member of the virtualization ready physical infrastructure runs the so-called reputation estimator, a software module responsible for computing a reputation score κᵢ, of each hosting machine i∈N.

A reputation value is assigned to hosting machine by all the other hosting machines available on the telecommunication network. The reputation value is then continuously updated as operations keep running and hosting machines show their level of reliability and participation. Practically speaking, a hosting machine that appears for the first time should receive a basic reputation score from all the other hosting machines. This score can be then progressively improved as the new hosting machine keeps hosting new virtualized elements (application nodes) while guaranteeing the desired level of QoS. In terms of practical implementation, each hosting machine is constantly informed of the state of the other hosting machines laying within a certain hop distance (information is shared through DASS, see Section 5). Then, each hosting machine merges this real-time information with the historical data available on the surrounding hosting machines to determine metrics such as:
Known total number of hours worked by a given hosting machine.
Known total number of virtualized elements served by a given hosting machine.
Historical availability ratio of a given hosting machine.
Known total number total number of migrations caused that involved a given hosting machine.
Historical average duration of the continuous operation interval (e.g., two hours per day) of a given hosting machine.
Etc.

These metrics are then elaborated by an algorithm to extract the instantaneous reputation score assigned to a surrounding hosting machine. The reputation values are constantly distributed across the hosting machines of the virtualization ready physical infrastructure, so that the final reputation value assigned to a hosting machine and used by the distributed multi-period orchestrator is the result of a collaborative estimation effort. In fact, due to the opportunistic nature of virtualization ready physical infrastructure management process, a hosting machine considered unreliable by a certain neighbor may be estimated as very efficient by another (due to past collaborations in a common virtualization ready physical infrastructure).

### 10 the Access Manager

This module has the responsibilities of managing the first interactions with a new hosting machine appeared as direct neighbor on the underlying telecommunication network. In particular, it will take care of:
Authenticating the hosting machine as authorized entity to participate to the virtualization ready physical infrastructure. For instance, only hosting machines with a certain MAC address can be white-listed.
Transmission of common orchestration parameters relevant for the distributed multi-period orchestration processes.
Retrieve the expected departure time and pre-planned destinations of the new hosting machine.

### 11 the Virtualization Engine

Each hosting machine participating to a virtualization ready physical infrastructure runs the so-called virtualization engine, i.e., a software module whose main responsibilities include:
Instantiate a virtualized element (application node) on the top of the hosting machine's operating system.
Guarantee isolation to the multiple virtualized elements (application nodes) hosted on the same hosting machine.
Share resources among multiple virtualized elements (application nodes) hosted on the same hosting machine according to pre-defined sharing ratio and priority policies.
Monitor virtualized element (application node) states.
Stop virtualized elements (application nodes).

Note that the OS and the physical hardware of a physical server running a virtualization engine must be configured to allow resource virtualization. For instance, with Intel machines, the Intel Virtualization Technology option must be enabled into the BIOS menu. Examples of popular virtualization engines include:
Docker Engine, LXD Engine, Kubernets Engine—Container technologies.
Hyper-V, VMWare vSphere, KVM, Xen Server—Virtual machine technologies.

The virtualization engine keeps informing the distributed multi-period orchestration instance of the same hosting machine about:
ωᵢᵣ: amount of resources available on the underlying hosting machine.
ηᵢₖᵣ: current hardware configuration of the underlying hosting machine.
The real time resource consumption figures observed for each hosted virtualized element (application node).

### 12 the Telecommunication Application

The whole virtualization ready physical infrastructure relies on a telecommunication network interconnecting all the hosting machine. In this implementation, the ad-hoc communication network built by the HEAVEN communication middleware is considered. HEAVEN is a middleware running in the user space, and thus potentially compatible with any kind of device without the need of modifying the underlying Operating System (OS).

HEAVEN builds a virtual network layer able to seamlessly interact (through dedicated virtual link layers) with different types of network transmission technologies. For instance, HEAVEN can manage Wi-Fi interfaces running in ad-hoc (or IBSS) mode [3], as well as Wi-Fi interfaces acting as base station or client in a traditional infrastructure mode.

HEAVEN offers the both unicast and broadcast communication services, by relying on three types of routing protocols:
1. Gossip: Each network node forwards all the packet in transit (not destined to him) to all the network neighbors and decreases the hop counter by 1. Caches are used to avoid forwarding duplicated packets. Gossip is perfect to serve signaling/overhead/coordination traffic generated by the Distributed Database running above.
2. Proactive and/or reactive shortest path: One or multiple shortest paths trees are computed by each network node (proactively or on-demand) to determine the next-hop to be used to forward a given packet toward its destination. In a fixed environment, the paths computed by this protocols are directly used to populate the path set P: routing become thus given and it is considered a problem parameter (all routing variables are fixed).
3. Dedicated flow-based routing: A dedicated path selected by the distributed multi-period orchestrator is allocated to serve a specific traffic demand (i,j)∈A_{z} of application z∈Z.

HEAVEN is responsible for discovering new available network nodes and authorizing them to participate to the network. HEAVEN provides all the APIs required by the architecture orchestrator to collect the network information related to the network parameters of the multi-period workload placement problem:
Physical graph/Network topology G^{P} (N, E), of the whole virtualization ready physical infrastructure or of the desired N-hop neighborhood:
   N, hosting machine set.
   E, physical link set.
   Eᵢ, set of physical link laying in the cell of the underlying nodes.
Routing path set P, if routing is problem parameter,
Current link and cell capacity values:
   cᵢⱼₕ, for instance by calling the private function of a mt7610u Wi-Fi interface called iwpriv [ifname] get adhocEntry. The same command is used also to return the link RSSI values.
   c̅ᵢ, or instance by using the Linux command iwconfig
Characterization of the nominal throughput-distance function corresponding to the underlying network interfaces (H^{ij}, lₕ⁺, lₕ⁻):

The telecommunication network is also meant to receive the bandwidth allocation instructions directly form the distributed multi-period orchestration instance running above.

### REFERENCES

[1] Inc. Amazon Web Services. Amazon Elastic Block Store, Persistent block storage for Amazon EC2. https://aws.amazon.com/ebs/, 2019. Online; accessed 12 Feb. 2019.
[2] J. Panerati, L. G. Gianoli, C. Pinciroli, A. Shabah, G. Nicolescu, and G. Beltrame. From Swarms to Stars: Task Coverage in Robot Swarms with Connectivity Constraints. In 2018 IEEE International Conference on Robotics and Automation (ICRA), pages 7674-7681. IEEE, may 2018.
[3] TP-Link Technologies Co. TP-Link, USB Adapters, Archer T2UH—Specifications. https://www.tp-link.com/us/products/details/cat-5520_Archer-T2UH.html#specifications. Online; accessed 20 Feb. 2019.

1. A system for enabling an execution of a plurality of tasks in a heterogeneous dynamic environment, the system comprising:
a plurality of heterogeneous host machines that are each characterized by corresponding processing resources, with each heterogeneous host machine comprising:
a telecommunication application configured to enable the heterogeneous host machine to be part of a telecommunication network with at least one other heterogeneous host machine;
a virtualization engine configured to execute a received virtualized element using the corresponding processing resources of the heterogeneous host machine; and
a geolocation module configured to provide at least an indication of a present position of the corresponding heterogeneous host machine; and
a distributed system orchestrator configured to manage an execution of a plurality of tasks using at least one of the plurality of heterogeneous host machines, wherein the plurality of tasks is comprised of a corresponding plurality of virtualized elements, with the distributed system orchestrator comprising:
a telecommunication application configured to enable the distributed system orchestrator to be part of the telecommunication network comprising at least one heterogeneous host machine of the plurality of heterogeneous host machines; and
a task assignment module configured to assign each virtualized element of the plurality of virtualized elements to a selected heterogeneous host machine located on the telecommunication network,
wherein the task assignment module assigns the virtualized element according to a given multi-period workload placement problem that is determined by the distributed system orchestrator using at least the indication of a present position of each available heterogeneous host machine and an indication of corresponding resource availability in at least one heterogeneous host machine of the plurality of heterogeneous host machines and in accordance with at least one given criterion.

2. The system according to claim 1, wherein the multi-period workload placement problem is determined by the distributed system orchestrator using information related to heterogeneous host machines joining or leaving the telecommunication network.

3. The system according to claim 1, wherein the telecommunication network comprises a virtual ad hoc mobile telecommunication network.

4. The system according to claim 1, wherein the multi-period workload placement problem is amended in response to a given event.

5. The system according to claim 4, wherein the given event comprises a change in resources available.

6. The system according to claim 4, wherein the amendment of the multi-period workload placement problem comprises transferring a virtualized element from a first given heterogeneous host machine directly to a second given heterogeneous host machine.

7. The system according to claim 1, wherein the heterogeneous host machines are wireless host machines, and wherein the at least one given criterion is selected from a group consisting of:
a minimization of host machine utilization costs;
a minimization of a number of migrations;
a minimization of energy consumption;
a minimization of refused workloads;
a minimization of host machine physical movements;
a throughput of at least one given host machine;
a spectrum sharing behavior between at least two pairs of host machines; and
an interference between at least two pairs of host machines.

8. The system according to claim 1, wherein the telecommunication application of the distributed system orchestrator reserves dedicated suitable routing paths according to the multi-period workload placement problem.

9. The system according to claim 1, wherein the given multi-period workload placement problem is further determined using at least one telecommunication network property.

10. The system according to claim 9, wherein the at least one telecommunication network property problem comprises at least one of:
a latency for transferring a first given virtualized element to a given heterogeneous host machine;
a latency for migrating a second given virtualized element from a first given heterogeneous host machine to a second given heterogeneous host machine; and
a network topology.

11. The system according to claim 1, wherein the geolocation module is further configured to provide an indication of a possible future position of the corresponding heterogeneous host machine; and wherein the given multi-period workload placement problem is further determined using the indication of a possible future position of the corresponding heterogeneous host machine.

12. The system according to claim 1, wherein each heterogeneous host machine is being assigned an indication of a corresponding reputation; further wherein the given multi-period workload placement problem is further determined using the indication of a corresponding reputation.

13. The system according to claim 1, wherein each heterogeneous host machine comprises an energy module for providing an indication of a corresponding level of energy available; and wherein the given multi-period workload placement problem is further determined using the indication of a corresponding level of energy available.

14. A method for enabling an execution of a plurality of tasks in a heterogeneous dynamic environment, the method comprising:
providing a plurality of heterogeneous host machines, each given heterogeneous host machine having corresponding processing resources, each given heterogeneous host machine comprising:
a telecommunication application for enabling the given heterogeneous host machine to be part of a telecommunication network with at least one other heterogeneous host machine,
a virtualization engine for executing a received virtualized element using the corresponding processing resources, and
a geolocation module for providing at least an indication of a present position of the given heterogeneous host machine;
providing a distributed system orchestrator for managing an execution of a plurality of tasks using at least one of the plurality of heterogeneous host machines with a corresponding telecommunication application for enabling the distributed system orchestrator to be part of the telecommunication network comprising at least one available heterogeneous host machine of the plurality of heterogeneous host machines and with a task assignment module for assigning each virtualized element of the plurality of virtualized elements to a selected heterogeneous host machine located on the telecommunication network;
receiving, using the distributed system orchestrator, a plurality of tasks to execute, each task comprising a corresponding plurality of virtualized elements;
obtaining, using the distributed system orchestrator, an indication of a present location of each available heterogeneous host machine;
obtaining, using the distributed system orchestrator, an indication of a resource availability for each available heterogeneous host machine;
determining, using the distributed system orchestrator, a multi-period workload placement problem using the received indication of a present location of each available heterogeneous host machine and the indication of a resource availability of each available heterogeneous host machine; and
for each task of the plurality of tasks, assigning each corresponding virtualized element of the plurality of corresponding virtualized elements to a corresponding host machine using the determined multi-period workload placement problem.

15. The method according to claim 14, further comprising executing each of the assigned virtualized elements using the corresponding heterogeneous host machine.

16. The method according to claim 14, wherein the telecommunication network comprises a virtual ad hoc mobile telecommunication network.

17. The method according to claim 14, further comprising amending the multi-period workload placement problem in response to a given event.

18. The method according to claim 17, wherein the given event comprises a change in resources available.

19. The method according to claim 14, wherein the amending of the multi-period workload placement problem comprises transferring a given virtualized element from a first given heterogeneous host machine to a second given heterogeneous host machine.

20. The method according to claim 14, wherein the determining of the multi-period workload placement problem is further performed using at least one property of the telecommunication network.

21. The method according to claim 14, further comprising:
receiving, from each of the plurality of heterogeneous host machines, an indication of a possible future location;
wherein the determining of the multi-period workload placement problem is further performed using the received indications of a possible future location.

22. The method according to claim 14, further comprising:
assigning, for each of the plurality of heterogeneous host machines, an indication of a corresponding reputation;
wherein the determining of the multi-period workload placement problem is further performed using the plurality of indications of a corresponding reputation.

23. The method according to claim 14, further comprising:
obtaining an indication of a corresponding level of energy available in each of the plurality of heterogeneous host machines;
wherein the determining of the multi-period workload placement problem is further performed using the obtained indications of a corresponding level of energy available.
